(19) United States
(12) Patent Application Publication
(10) Pub. No.: US 2018/0365598 A1
(43) Pub. Date: Dec. 20, 2018

(54) APPARATUS, ARTICLE, SYSTEM AND METHOD FOR AUTOMATED ELECTRONIC MANAGEMENT OF PARKING SPACE RENTAL TRANSACTIONS IN MARKETPLACE FOR PARKING SPACE RENTALS

(71) Applicant: AireSpaces Ventures, LLC, Houston, TX (US)

(72) Inventor: Randall H. Jamail, Houston, TX (US)

(73) Assignee: AireSpaces Ventures, LLC, Houston, TX (US)

(21) Appl. No.: 15/623,638

(22) Filed: Jun. 15, 2017

(51) Int. Cl. G06Q 10/02; G06F 17/30; G08G 1/14

(52) U.S. Cl. CPC G06Q 10/02; G06Q 2240/00; G08G 1/144; G06F 17/30864

(57) ABSTRACT

Disclosed subject matter includes apparatus, article, system, and method for automated electronic management of parking space rental transactions in a marketplace for parking space rentals over a distributed communications network.

### CROSS-REFERENCE TO RELATED APPLICATIONS

N/A

### FIELD OF INVENTION

The present disclosure relates to automated electronic apparatuses, articles, systems, and methods for management of parking space rental transactions for vehicles, and a marketplace for parking space rentals over a distributed communications network.

### BACKGROUND OF INVENTION

Locating parking spaces for vehicles in crowded, hectic urban environments often presents difficulties for drivers and vehicle owners. These difficulties are encountered, for example, by drivers visiting cities where they have no regular residence, and in their own cities when travelling to areas and locations where their destination lacks adequate parking and they do not rent permanent or long-term, parking spaces by contracts with parking lot services or parking garages. Particular difficulties may be encountered, for example, when driving and seeking to park at or near venues for mass events such as concerts, festivals and sporting events. Drivers who happen to be in the same area, but not attending a mass event, nonetheless may encounter great difficulties locating a convenient parking space in the area, of such an event.

In order to secure a parking spot in a crowded urban area, drivers often must “scout” for an unoccupied parking space by repeatedly driving around or through a general area where they desire to park, waiting and hoping for a parking space to become available in their field of view as they approach in their vehicle. Drivers thus find it necessary to actively scout for an unoccupied parking space in their field of view while driving, without prior knowledge of where such an unoccupied parking space may be located, or whether any parking spaces are available at all in the desired area. The ad hoc practice of scouting for a parking space by visual search and opportunistic discovery of unoccupied parking spaces while driving is distracting, frustrating, inefficient, time-intensive and unpredictable. The ad hoc practice of scouting for parking spaces also places unnecessary demands on the environment such as, for example, wasteful consumption of hydrocarbon fuels and creation of carbon pollution. Where a driver finds it necessary to park in a pay lot or garage, immediate need for the driver to locate a parking space to avoid or bring to an end the problems of scouting, and avoid disruption of the driver's schedule, often creates leverage that enables the operators of pay lots or garages to set relatively high prices that would not be reached if the driver did not encounter acute need to park her vehicle.

Disclosed subject matter includes automated electronic apparatuses, systems and methods for managing parking space rental transactions, including informing drivers of availability, pricing and locations of parking spaces for rent in a marketplace for parking space rentals offered by numerous hosts who own or control parking spaces in an area; performing transactions to rent parking spaces; and to provide drivers authorized access to the rented parking spaces. Disclosed subject matter includes an automated electronic marketplace for parking space rentals offered by numerous hosts who own or control parking spaces in an area. Disclosed, subject matter provides apparatuses, systems and methods for owners or lessors of parking spaces to inform drivers of availability, pricing and locations of parking spaces, perform transactions to rent parking spaces to drivers, and provide authorized access to rented parking spaces for drivers.

Disclosed subject matter may eliminate visual scouting for unoccupied parking spaces. Disclosed embodiments also may reduce or eliminate problems associated with scouting, including for example, distraction, frustration, inefficiency, time demands, unpredictability; unnecessarily high prices and rents to lot and garage operators due to inelastic demand created by acute need for drivers to park their vehicles; and environmental demands such as wasted, consumption of hydrocarbon fuels and creation of carbon pollution.

### BRIEF SUMMARY OF THE INVENTION

Disclosed subject matter includes automated electronic apparatuses, systems and methods for managing parking space rental transactions, including informing drivers of availability, pricing and locations of parking spaces for rent in a marketplace for parking space rentals offered, by numerous hosts who own or control parking spaces in an area; performing transactions to rent parking spaces; and to provide drivers authorized access to the rented, parking spaces. Disclosed subject matter includes an automated electronic marketplace for parking space rentals offered by numerous hosts who own or control parking spaces in an area. Disclosed subject matter provides apparatuses, systems and methods for owners or lessors of parking spaces to inform drivers of availability, pricing and locations of parking spaces, perform transactions to rent parking spaces to drivers, and provide authorized access to rented parking spaces for drivers.

Disclosed subject matter includes apparatuses, systems and methods that may provide improved parking access and transferability, including a mobile application for the same.

In embodiments, a system may include the mobile devices, such as smartphones, for a plurality of driver users, in communication with a server over a distributed communications network. Each driver user may utilize their mobile device to access the server and request information for parking space listings at or near a destination of the driver user's choice.

Embodiments may increase the efficiency of drivers discovering parking spaces, and may additionally provide further benefit by enabling parking spaces to be reserved, accessed, or transferred.

Embodiments may foster a social community that may leverage parking availability and usage to benefit users.

Embodiments may provide a peer-to-peer marketplace that may allow property owners to rent private property in the form of parking spaces to drivers.

In embodiments, property owners (hosts) may be able to easily list their unused, private parking spaces and users (drivers) may be able to easily reserve and pay in advance for these parking spaces. Embodiments may provide an automated marketplace for locating and rental of parking spaces in transactions between hosts and drivers, with reduction of difficulties and transaction costs.

In embodiments, hosts may list their parking spaces and pertinent details through the platform, populating in the system's parking space database.

In embodiments, for hosts who have agreed to commit a portion or all of their parking inventory to the system's inventory of spaces, the platform may manage and track availability for all spaces listed, within, the system. Thus when a driver searches for parking in a specified geographic location and within a specified time range, the platform will only return results of parking spaces that are available in that area, and for the specified time, allowing the driver to confidently reserve parking in advance.

In embodiments, the system may enable automated communication of information and rental transactions for listed parking spaces. Host users may input listing information such as: the geographic location or address of listed parking spaces, number of available parking spaces at a location or address, types of spaces such as covered/uncovered, sizes of spaces, pricing/rates, and hours when parking spaces are available.

In such an embodiment each driver user may create a unique user account and input personal information, such as but not limited to, personal identification information, vehicle identification information, and payment information into the system. Each host user may input parking space listing information as described in the preceding paragraph.

In embodiments, a downloadable software application may be stored and processed on each, user's wireless mobile device, such as a smartphone, tablet, computing device, or other wireless device.

Disclosed subject matter may eliminate visual scouting for unoccupied parking spaces. Disclosed embodiments also may reduce or eliminate problems associated with scouting, including for example, distraction, frustration, inefficiency, time demands, unpredictability; unnecessarily high prices and rents to lot and garage operators due to inelastic demand created by acute need for drivers to park their vehicles; and environmental demands such as wasted consumption of hydrocarbon fuels and creation of carbon pollution.

### BRIEF DESCRIPTION OF THE DRAWINGS

The novel features believed characteristic of the disclosed subject matter will be set forth in any claims that are filed later. The disclosed subject matter itself, however, as well as mode of use, further objectives, and advantages thereof, will be understood by reference to the following detailed description of an illustrative embodiment when read in conjunction with the accompanying drawings.

FIG. 1 is a simplified block diagram illustrating an automated electronic system for managing parking space rental transactions over a distributed communications network, in an embodiment.

FIG. 2 is a block diagram illustrating further details of a system shown generally in FIG. 1.

FIG. 3 is a simplified flow diagram illustrating aspects of an automated electronic method for managing parking space rental transactions over a distributed communications network, in an embodiment.

FIG. 4 is a simplified flow diagram illustrating aspects of an automated electronic method for managing parking space rental transactions over a distributed communications network, in an embodiment.

FIG. 5 is a simplified flow diagram illustrating aspects of an automated electronic method for managing parking space rental transactions over a distributed communications network, in an embodiment.

FIG. 6 is a simplified block diagram illustrating aspects of an automated electronic system for managing parking space rental transactions over a distributed communications network, in an embodiment.

FIGS. 7-34 illustrate exemplary screen shots of prompts and displayed information on a user device for aspects of automated electronic apparatuses, systems and methods for managing parking space rental transactions over a communications network, in an embodiment.

### DETAILED DESCRIPTION OF EMBODIMENTS

Reference now should be made to the drawings, in which the same reference numbers are used throughout the different figures to designate the same components.

It will be understood, that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to wireless smartphones, wireless computing devices, wireless tablet computing devices, personal computers, and the Internet, one skilled, in the art can apply the principles discussed herein, to any computing and communications environment including any combination of, for example, mobile computing, smartphones, tablet computers, wireless computing devices, cloud computers, or other computing devices or resources in communication, Further, one skilled in the art could apply the principles discussed herein to communication mediums and networks other than the Internet.

An exemplary system within, a computing environment for implementing the disclosure may include computing devices and computing systems. Components of such computing systems may include, but are not limited, to, a processing unit, a system memory, and a system bus that couples various system components including the system memory to the processing unit. The system bus may be any of several types of bus structures including a memory bus or memory controller, a peripheral bus, or a local bus using any of a variety of bus architectures.

Computing systems may include memory, computer readable media and storage media. By way of example, and not limitation, computer readable media may comprise cloud storage, computer storage media, and communication media. Memory may contain, for example, data and/or program modules that are accessible to and/or presently operated on by a processing unit. By way of example, and not limitation, an operating system, application programs, other program modules and program data may be included.

The drives and computer storage media may provide storage of computer readable instructions, data structures, program modules and other data for the computing system. For example, hard drives may store operating system, application programs, other program, modules, and program data.

Such a computing system may operate in a networked, environment using logical connections to one or more remote computers, such as a remote computing system, over a distributed communications network. A system may include personal computers, mobile electronic devices, servers, routers, networked computers, peer devices, other common network nodes, cloud computers, and/or cloud devices. Logical connections may include local area networks (LAN) connecting through network interfaces, and may also include other networks. Such networking environments are commonplace in offices, enterprise-wide computer networks, intranets, the Internet and wireless mobile phone communications network infrastructure.

For the purposes of this disclosure, it is appreciated that the terms “device”, “processor based mobile device”, “mobile device”, “electronic device”, “processor based mobile electronic device”, “mobile electronic device”, and “location-capable wireless device” may be synonymous.

Software programs or modules may instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor, or in a combination of hardware and software module.

Furthermore, software operations may be executed, in part or wholly, by one or more servers or a client's system, via hardware, software modules, or combination. Software modules may include executable code residing in memory in any form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). A bus may be an optical or conventional bus operating pursuant to various protocols that are known in the art.

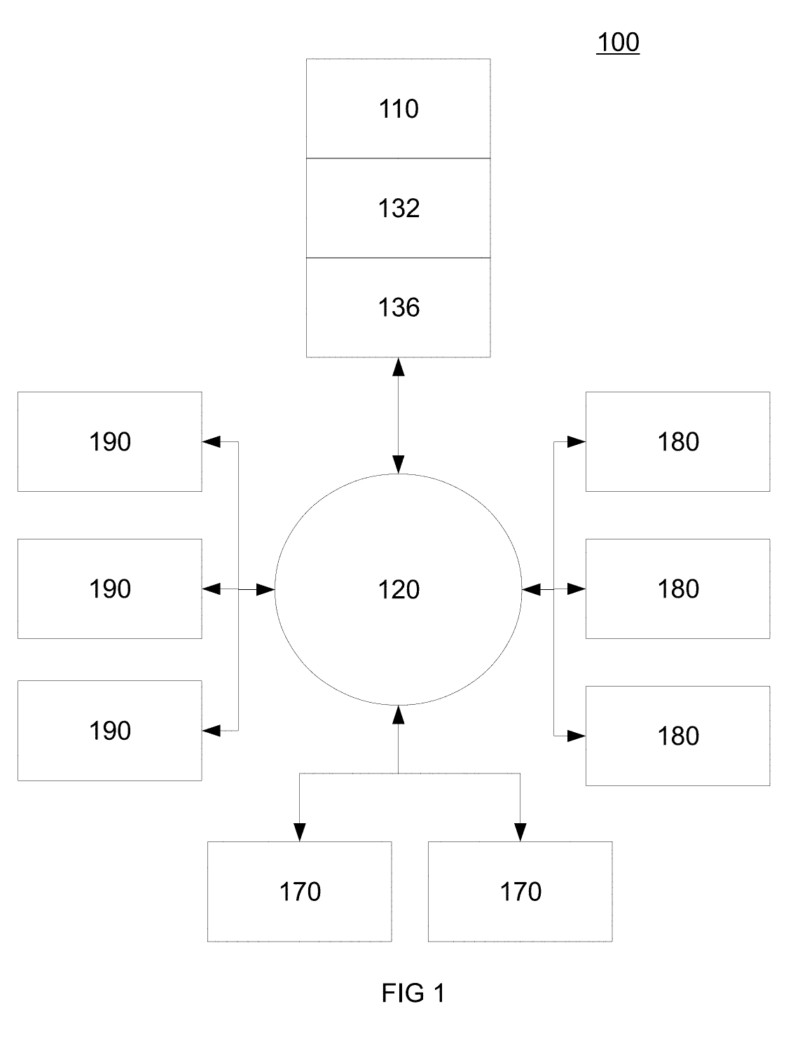

FIG. 1 is a simplified block diagram illustrating an automated electronic system 100 for managing parking space rental transactions over a distributed communications network, in an embodiment. System 100 may include a server 110. Server 110 may include a processor 132 operably coupled to memory 134. Server 110 may include a network adapter 136 operably coupled to the processor 132 for enabling communication over a distributed communications network 120. It will be understood that distributed communications network 120 may be provided by any suitable combination of distributed communications network infrastructure such as the Internet, mobile smartphone network infrastructure, and wireless mobile device communications infrastructure. System 100 may include a personal computer 170, such as a desktop or laptop computer. System 100 may include a GIS or mapping application server 180 in communication with server 110, personal computer 170, and/or user wireless device 190 over the communications network 120. System 100 may include a user wireless device 190, such as a smartphone, wireless tablet computing device, or other wireless mobile device, for a plurality of users in communication with server 110 and/or mapping application server 180 over communications network 120.

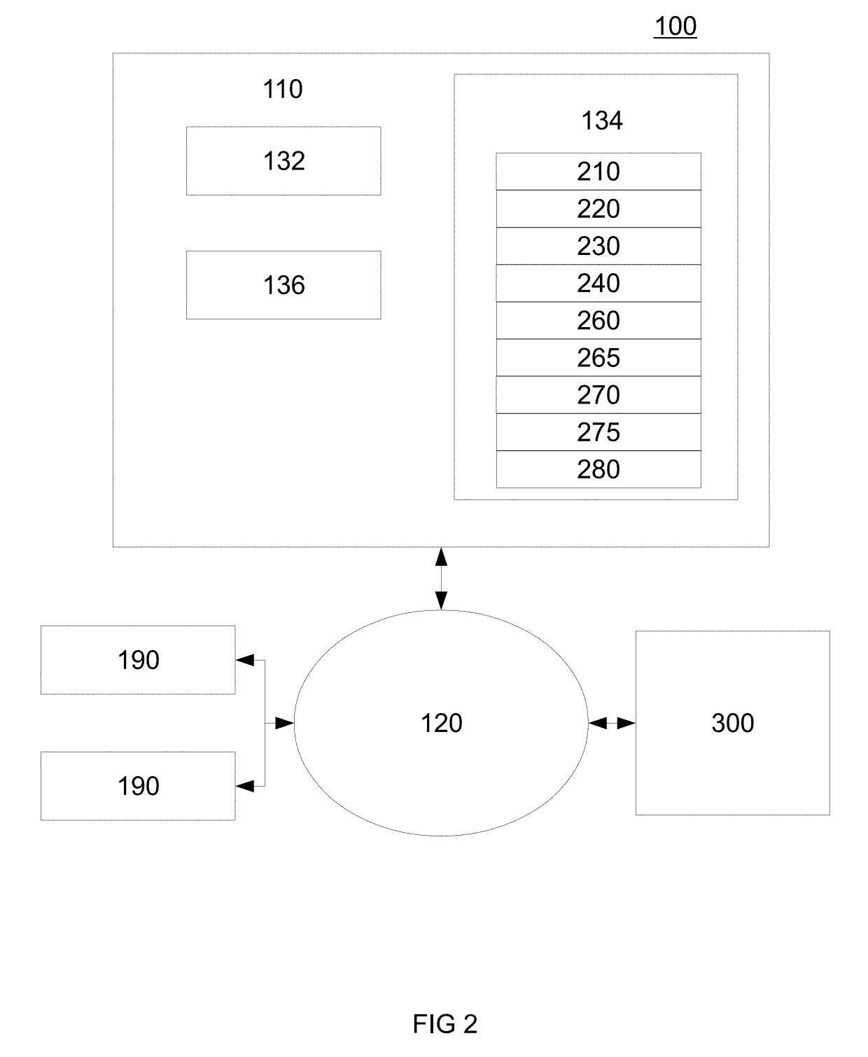

FIG 2 is a block diagram illustrating further details of a system 100 shown generally in FIG. 1. In an embodiment, server 110 may include executable code stored, in memory 134 and accessible by processor 132 to provide a plurality of modules 210-260 of an automated electronic system for managing parking space rental transactions in an automated marketplace for parking space rentals.

System 100 may include a user onboarding module 210 providing a user profile. The user onboarding module 210 may provide a user onboarding prompt to a display of a user wireless device 190. The user onboarding module 210 may receive user profile input responsive to the user onboarding prompt. The user onboarding module 210 may process user profile input to provide a user profile. The user profile may include at least one of the following: driver user profile information including a driver identifier, and host user profile information including a host identifier. The user profile may include both driver user profile information and host user profile information. It will be understood that a “host” or “host user” is a party that owns or controls real property which includes parking spaces for rent by driver users.

System 100 may include a host dashboard module 220. Such a host dashboard module 220 may provide a host management input prompt to a display of a user wireless device 190 or personal computer (180 in FIG. 1) of a host user. Referring to FIG. 2, the host dashboard module 220 may receive host management input in relation to the host management input prompt. The host dashboard module 220 may process host management input to provide host management information in relation to the host identifier.

System 100 may include a listings management module 230. The listings management module 230 may provide a listing management input prompt. The listings management module 230 may receive listing management input in relation to the listing management input prompt. The listings management module 230 may provide a listing creation input prompt. The listings management module 230 may receive listing creation input in relation to the listing creation prompt. The listings management module 230 may process the listing creation input to provide listing creation information in relation to a host identifier. The listings management module 230 may process the listing management input to provide listing management information in relation to a host identifier. The listing management information may be associated in a listing management information hierarchy as follows: a listing group identifier in relation to a common listing address, a listing group type identifier in relation to a common listing group identifier, and a listing space identifier defined in relation to a common listing group type identifier. It will be understood that such a listing space identifier may uniquely identify a listing, i.e., a unique listing for a particularly identified parking space that the related host user, i.e. the property owner or third party parking rental manager identified as having control and authority to rent out the parking space during a period of time, has made available for rental. It will be understood that such a listing group type identifier may identify a group of listings or parking spaces at a common address that share a common parking space attribute such as, for example, size of the parking space, condition such as covered, condition such as uncovered, condition such as indoor space, condition such as outdoor space, condition such as directly condition such as garage off street level, condition such as limited access due to vertical clearance. It will be further understood that a listing group type identifier for size of parking space may be identified in a manner such as, for example, compact size, mid-sized, small SUV size, large SUV size, oversized. It will be understood that another module, such as a space finding module 240, may process listing information in relation to listing group type identifier for size to provide information for a drivers, such as drivers of compact cars, of listings for parking spaces of multiple sizes, such, as spaces of corresponding size and larger size. A listing group identifier may commonly identify all listings, i.e. listed parking spaces, located at a common physical address.

System 100 may include a parking space database 300 in communication with the server 110 and/or user wireless devices 190 and storing parking space information including at least the following: listing space identifier, listing group type identifier, listing group identifier, listing address, listing size identifier, and listing status information.

System 100 may include space finding module 240 providing a space finding prompt to a display of a driver user wireless device. The space finding module 240 may receive space finding input responsive to the space finding prompt. The space finding module 240 may process the space finding input to provide space availability information in relation to driver destination information and driver destination time window information.

System 100 may include a driver reservation request module 260 providing a reservation request input prompt. The driver reservation request module 260 may receive reservation request input responsive to the reservation request input prompt. The driver reservation request module 260 may process reservation request input in relation to listing management information to provide driver reservation request information.

System 100 may include a host reservation management module 265 providing a reservation management input prompt to a display of a host user device. The host reservation management module 265 may receive reservation management input responsive to the reservation management input prompt. The host reservation management module 265 may process the reservation management input to provide reservation management information in relation to driver reservation request information.

System 100 may include a space blocking module 270 providing a blocking input prompt to a display of a driver user device or host user device. The space blocking module 270 may receive blocking input responsive to the blocking input prompt. The space blocking module 270 may process the blocking input to provide space blocking information in relation to reservation management information for a listing. It will be understood, that a “listing” refers to a parking space listed, or made available for rental on system 100 by a host user.

System 100 may include a reservation extension module 275 providing an extension input prompt to a display of a driver user mobile device, The reservation extension module 275 may receive extension input responsive to the extension input prompt. The reservation extension module 275 may process the extension input to provide reservation extension information in relation to reservation management information for a listing.

System 100 may include an advance reservation search module 280 providing an advance reservation search input prompt. The advance reservation search module 280 may receive advance reservation search input responsive to the advance reservation search input prompt. The advance reservation search module 280 may process the advance reservation search input to provide advance reservation information in relation to a future destination and a future time window for a driver user.

In embodiments, application software accessed on a mobile device 190 or personal computer 180 of a driver user or host user may be distinguished, displayed and accessed in two sides or modes, designated as a Driver Side and a Host Side. Such application software when initially opened may default to the Driver Side. In subsequent sessions, the application software may open to the side last used.

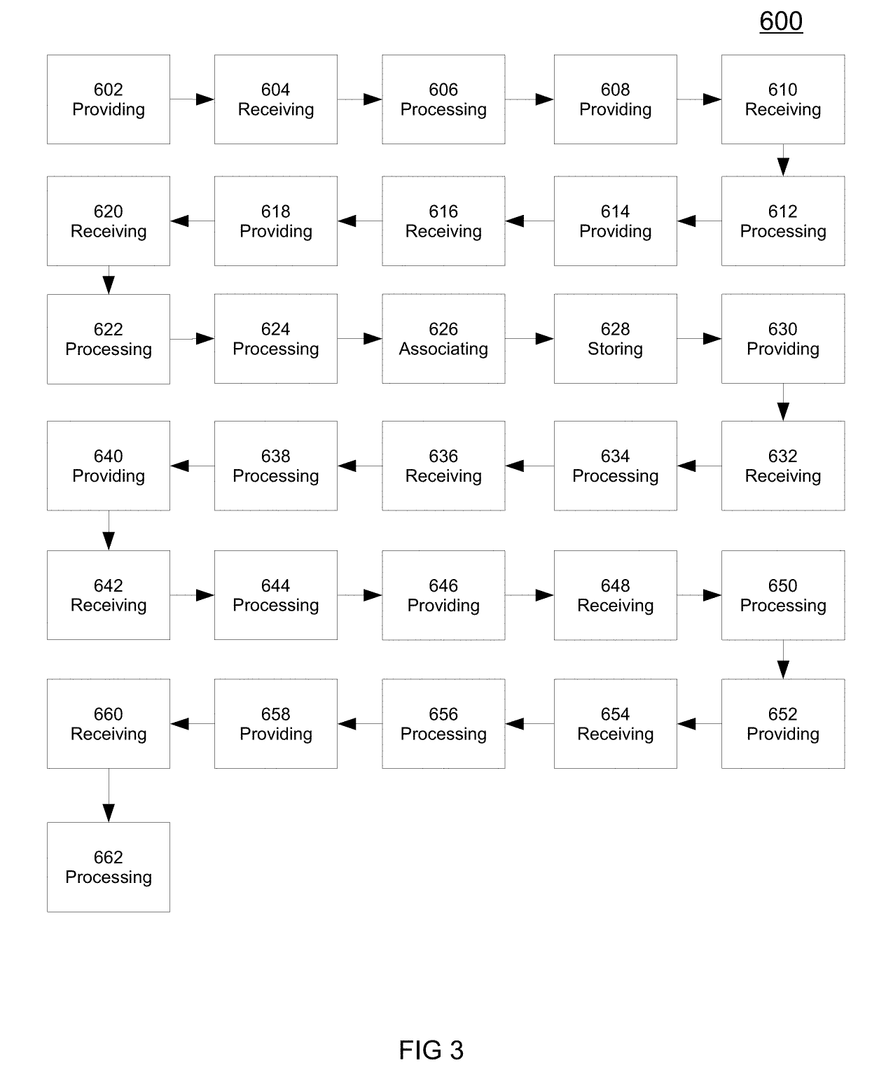

FIG. 3 is a simplified flow diagram illustrating aspects of a method 600 for automated electronic management of parking space rental transactions in a marketplace for parking space rentals over a distributed communications network, in an embodiment. It will be understood that method 600 may be implemented by a server and remote devices of a plurality of driver users and host users in communication over the distributed communications network, as described elsewhere herein for system 100.

Method 600 may include providing 602 a user profile prompt by a user onboarding module. Method 600 may include receiving 604 user profile input responsive to the user profile prompt. Method 600 may include processing 606 the user profile input to create a user profile. The user profile may include at least one of the following: driver user profile information including a driver identifier, and/or host user profile information including a host identifier.

Method 600 may include providing 608 a host management input prompt by a host dashboard module. Method 600 may include receiving 610 host management input in relation to the host management input prompt. Method 600 may include processing 612 host management input to provide host management information by the host dashboard module. The host host management information may be provided in relation to the host identifier.

Method 600 may include providing 614 a listing management input prompt by a listings management module. Method 600 may include receiving 616 listing management input by the listing management module in relation to the listing management input prompt. Method 600 may include providing 618 a listing creation input prompt by the listings management module. Method 600 may include receiving 620 listing creation input in relation to the listing creation prompt, by the listings management module. Method 600 may include processing 622 the listing creation input to provide listing creation information in relation to a host identifier, by the listings management module. Method 600 may include processing 624 the listing management input to provide listing management information in relation to a host identifier. Method 600 may include associating 626 the listing management information in a listing management information hierarchy as follows: a listing group identifier in relation to a common listing address, a listing group type identifier in relation to a common listing group identifier, and a listing space identifier defined in relation to a common listing group type identifier. It will be understood that such a listing space identifier may uniquely identify a listing, i.e., a unique listing for a particularly identified parking space that the related host user, i.e. the property owner or third party parking rental manager identified as having control and authority to rent out the parking space during a period of time, has made available for rental. It will be understood that such a listing group type identifier may identify a group of listings or parking spaces at a common address that share a common parking space attribute such as, for example, size of the parking space, condition such as covered, condition such as uncovered, condition such as indoor space, condition such as outdoor space, condition such as directly exiting at street level, condition such as surface lot, condition such as garage off street level, condition such as limited, access due to vertical clearance, it will be further understood that a listing group type identifier for size of parking space may be identified in a manner such as, for example, compact size, mid-sized, small SUV size, large SUV size, oversized. It will be understood that listing information may be processed, in relation to listing group type identifier for size to provide information for a drivers, such as drivers of compact cars, of listings for parking spaces of multiple sizes, such as spaces of corresponding size and larger size. A listing group identifier may commonly identify all listings, i.e. listed parking spaces, located at a common physical address.

Method 600 may include storing 628 parking space information in a parking space database. The parking space information may include at least the following: listing space identifier, listing group type identifier, listing group identifier, listing address, listing size identifier, and listing status information. Listing status information may include, for example, “available for rental” status identifier when a listing is not rented by another driver user, and “occupied” status identifier when a listing is rented by another driver user.

Method 600 may include providing 630 a space finding input prompt, by a space finding module. Method 600 may include receiving 632 space finding input responsive to the spaced finding prompt, by the space finding module. Method 600 may include processing 634 the space finding input, by the space finding module, to provide space availability information in relation to driver destination information and driver destination time window information.

Method 600 may include providing 636 a reservation request input prompt, by a driver reservation request module. Method 600 may include receiving 636 reservation request input responsive to the reservation request input prompt, by the driver reservation request module. Method 600 may include processing 638 reservation request input in relation to listing management information to provide driver reservation request information.

Method 600 may include providing 640 a reservation management input prompt, by a host reservation management module. Method 600 may include receiving 642 reservation management input responsive to the reservation management input prompt, by the host reservation management module. Method 600 may include processing 644 the reservation management input to provide reservation management information in relation to driver reservation request information.

Method 600 may include providing 646 a blocking input prompt, by a space blocking module. Method 600 may include receiving 648 blocking input responsive to the blocking input prompt, by the space blocking module. Method 600 may include processing 650 the blocking input to provide space blocking information in relation to reservation management information for a listing. Blocking input may, for example, include a photograph of another vehicle occupying a listed, parking space that is rented, or is intended to be rented, to a driver user arriving at the listed parking space to park her vehicle, license tag information, and make/model/color information for the vehicle blocking the listed parking space.

Method 600 may include providing 652 an extension input prompt to a mobile device of a driver user for extending the duration of a parking space rental, by a reservation extension module. Method 600 may include receiving 654 extension input responsive to the extension input prompt, by the reservation extension module. Method 600 may include processing 656 the extension input to provide reservation extension information in relation to reservation management information for a listing.

Method 600 may include providing 658 an advance reservation search input prompt, by an advance reservation search module. Method 600 may include receiving 660 advance reservation search input responsive to the advance reservation search input prompt, by the advance reservation search module. Method 600 may include processing 662 the advance reservation search input by the advance reservation search module to provide advance reservation information in relation to a future destination and a future time window for a driver user.

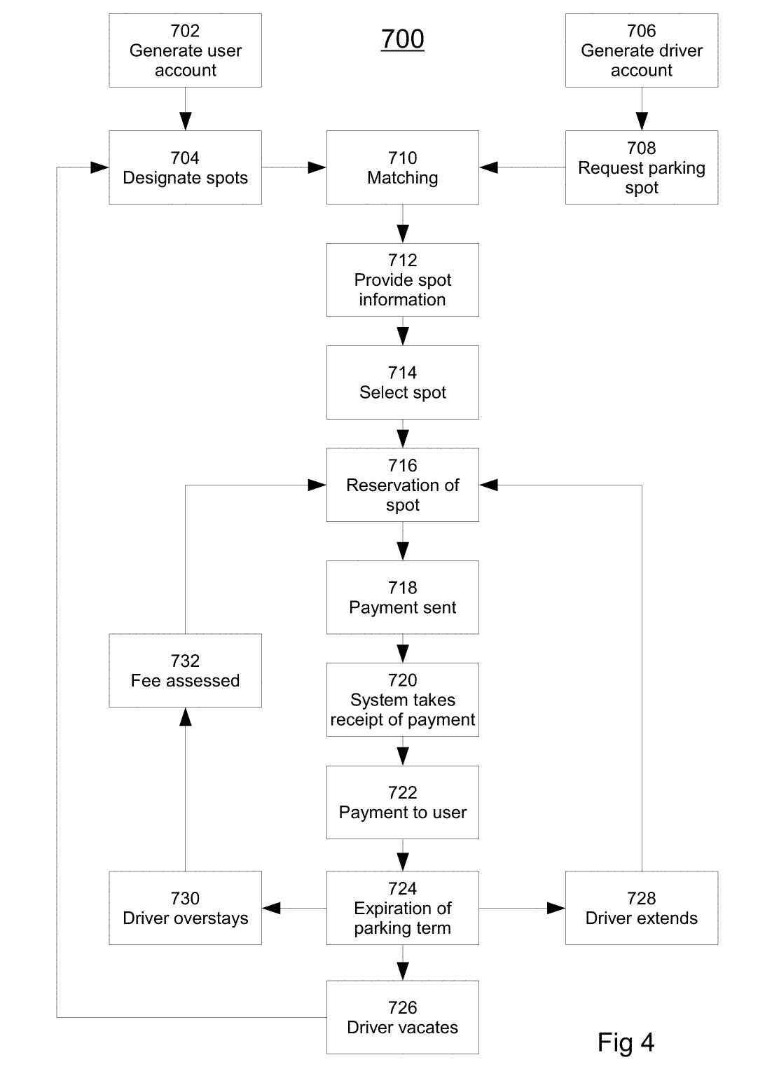

FIG. 4 is a simplified flow diagram illustrating aspects of a method 700 for automated electronic management of parking space rental transactions in a marketplace for parking space rentals over a distributed communications network, in an embodiment. Method 700 may include generating 702 a user account, Method. 700 may include designating 704 parking spots of a user account. Method 700 may include generating 706 a driver account. Method 700 may include requesting 708 a parking spot. Method 700 may include matching 710 at least one parking spot to a request. Method 700 may include providing 712 parking spot information for a spot matched to a request. Method 700 may selecting 714 a parking spot in relation to the matching 710 and providing 712 of parking spot information. Method 700 also may include reserving 716 the selected parking spot. Method 700 may further include sending 718 payment to rent the reserved parking spot. Method 700 may include taking 720 payment for the rental of the reserved parking spot. Method 700 may include making payment 722 to the user for rental of the parking spot. Method 700 may include determining expiration 724 of the rental period for the parking spot. Method 700 also may include the driver extending 728 the rental period for the parking spot, such as by making additional payment for same. Method 700 may include the driver vacating 726 the parking spot by expiration of the rental period. Method 700 may include overstaying 730 past expiration of the rental period, by the driver failing to vacate or extend, the rental period. Method 700 may include assessment 732 of an overstay fee against the driver who has overstayed past expiration of the rental period without extending the rental period.

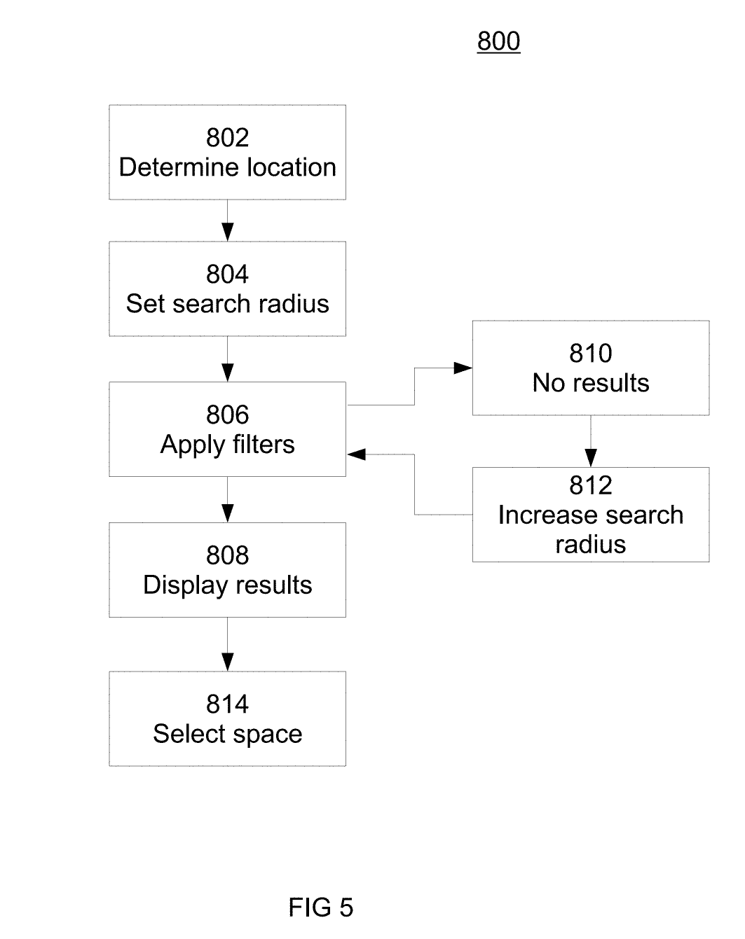

FIG. 5 is a simplified flow diagram illustrating aspects of a method 800 for automated electronic management of parking space rental transactions in a marketplace for parking space rentals over a distributed communications network, in an embodiment. Method 800 may include determining 802 location of parking spots in relation to location or planned location of a driver. Method 600 may include setting 804 search radius for identifying location of parking spots. Method 800 may include applying 806 filters to identify parking spots meeting search criteria of the driver. Method 800 may include increasing 812 search radius where the search identifies 810 no results for the driver. Method 800 includes displaying 808 results of the search for selecting 814 of a space by the driver.

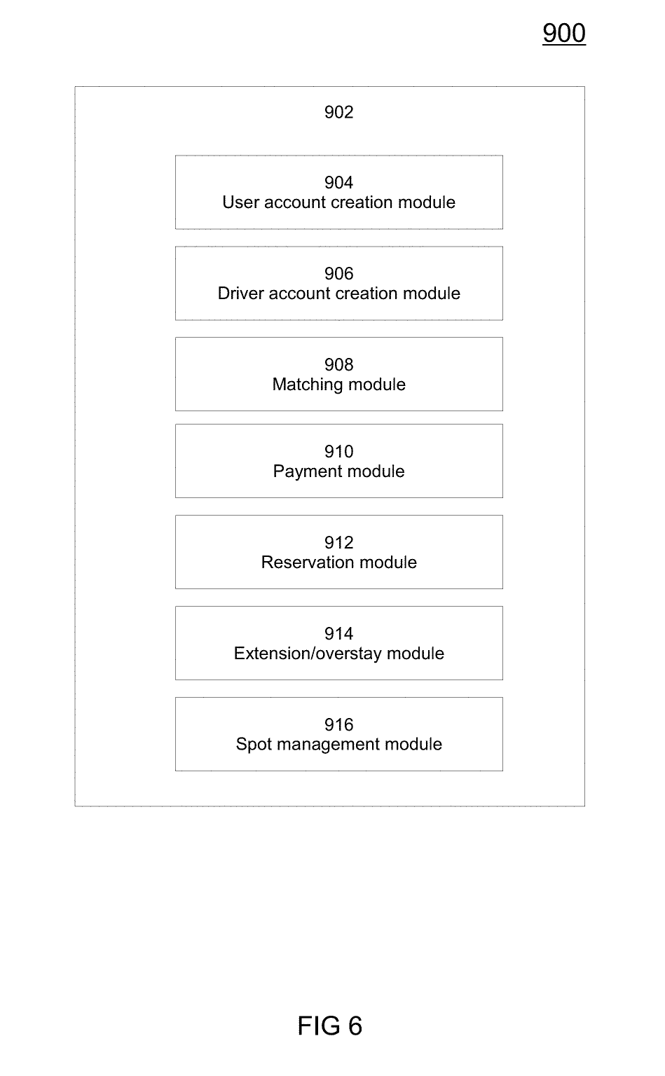

FIG. 6 is a simplified block diagram illustrating aspects of a system 900 for automated electronic management of parking space rental transactions in a marketplace for parking space rentals over a distributed communications network, in an embodiment. System 900 may include parking space rental management server 902 in communication with a plurality of driver wireless devices. System 900 may include user account creation module 904 for creating user accounts. System 900 may include driver account creation module 906 for creating driver accounts. System 900 may include matching module 908 for matching parking spots identified by a search with driver requests for parking spot rentals. System 900 may include a payment module 910 for receiving payments from drivers and making payments to users who are renting parking spots to the drivers. System 900 may include reservation module 912 for reserving parking spots which have been rented by drivers. System 900 may include parking spot management module 916 for managing the inventory and status of parking spots, requests for parking spots by drivers, and other aspects of transactions and. recording the status of parking spots in inventory. System 900 may include extension/overstay module 914 for managing extensions and. overstay fees for parking spots where rentals have expired.

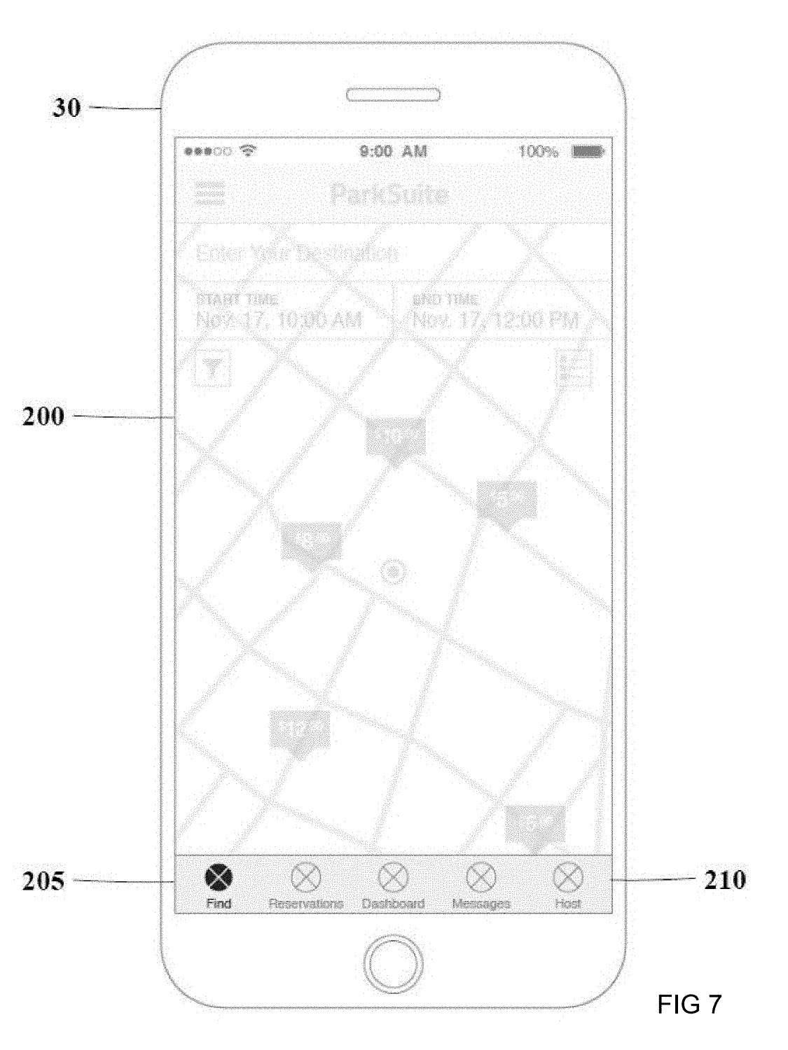

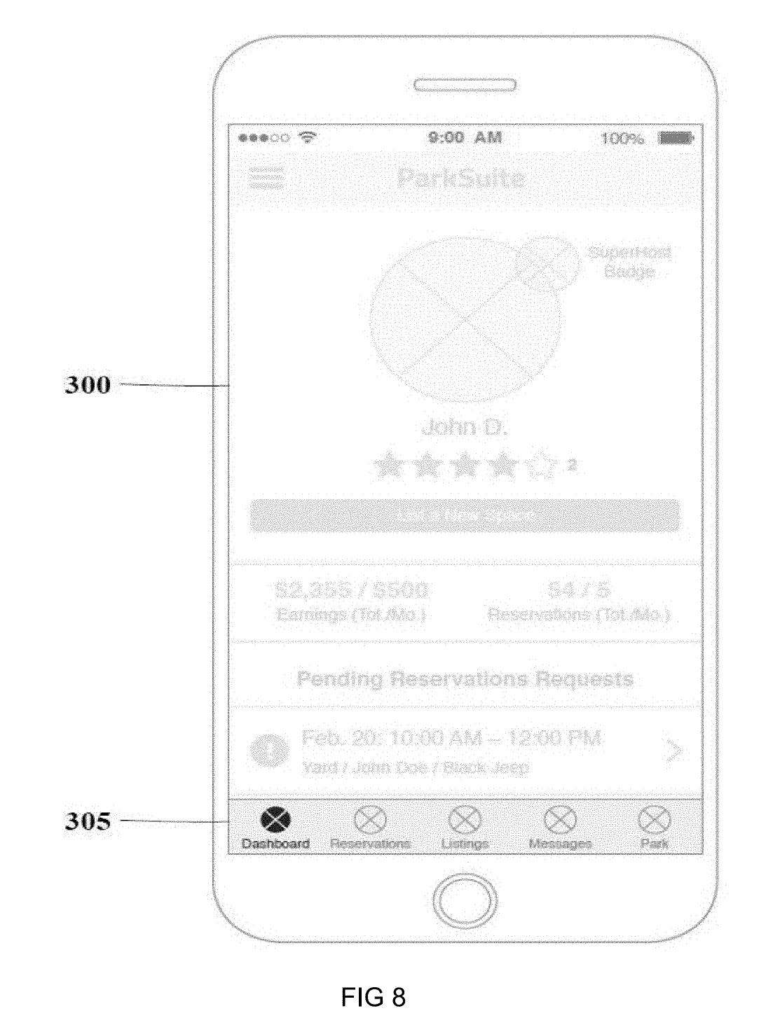

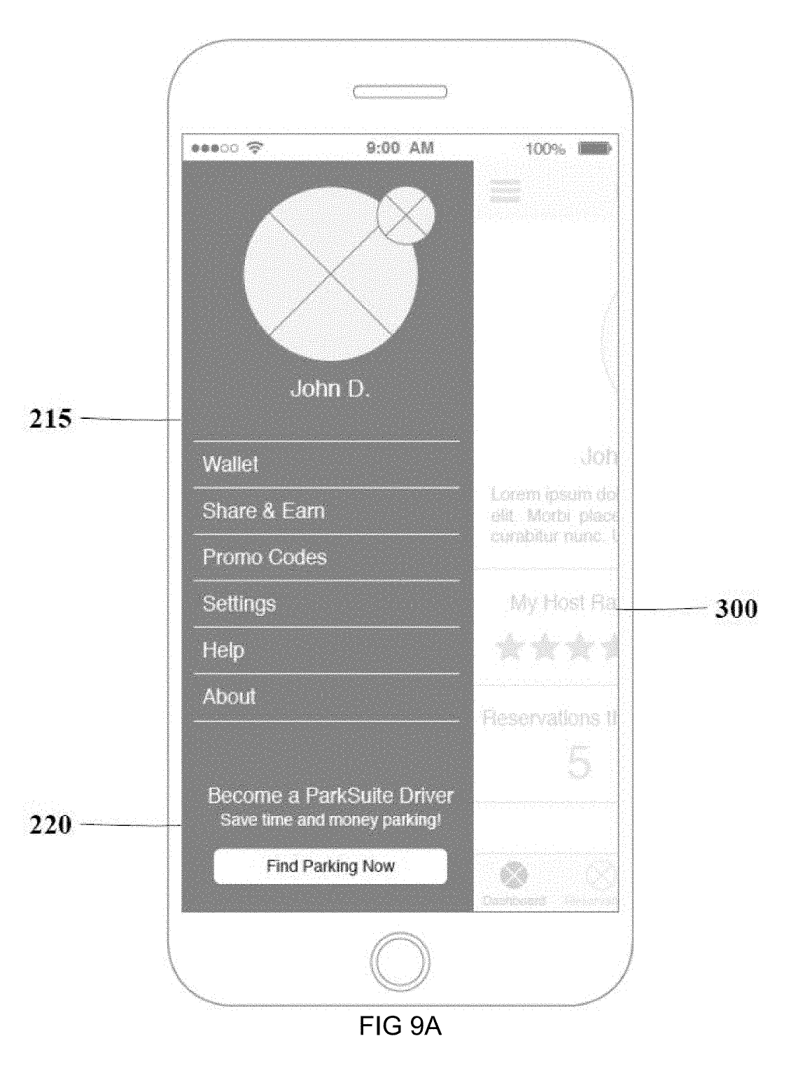

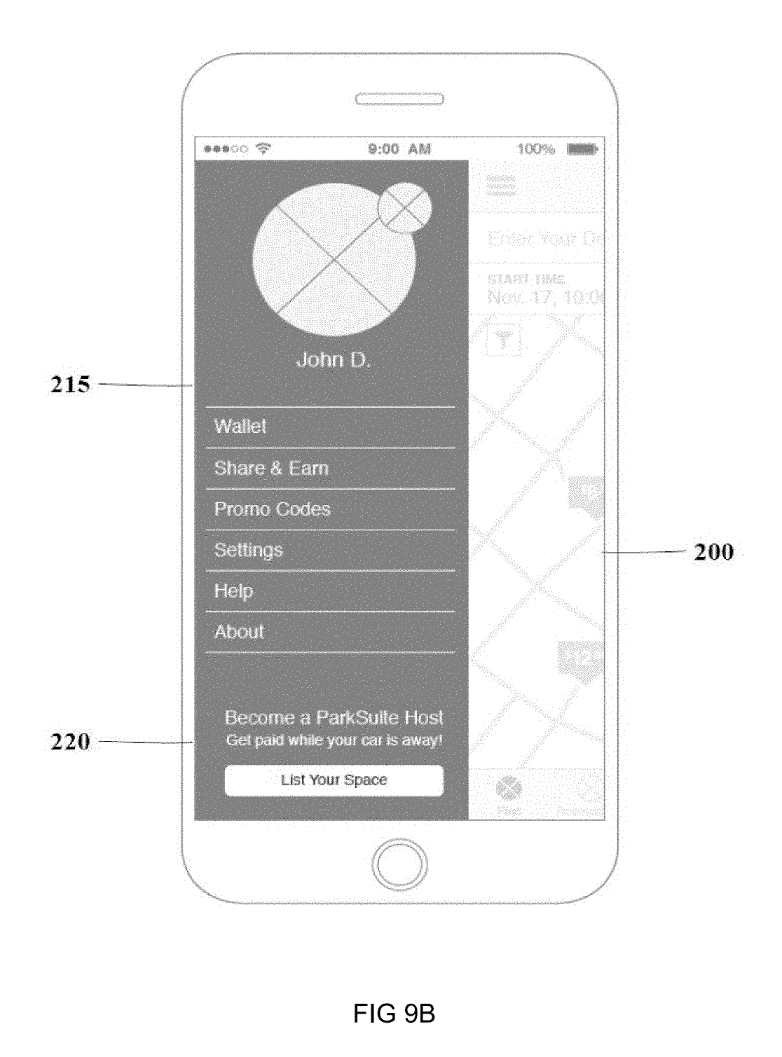

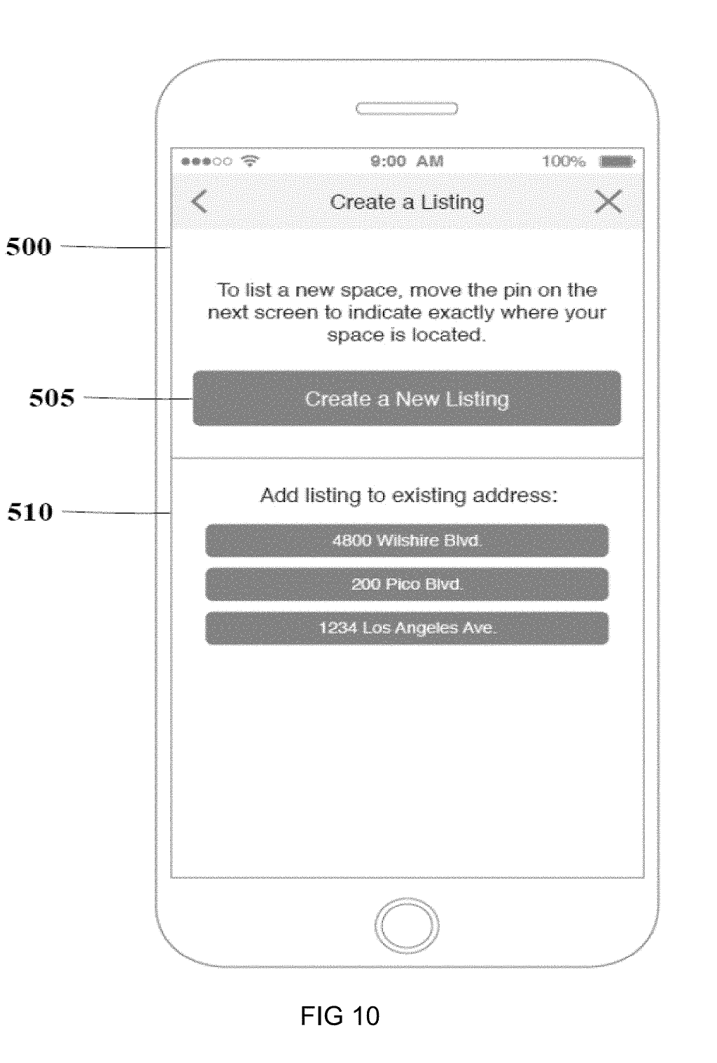

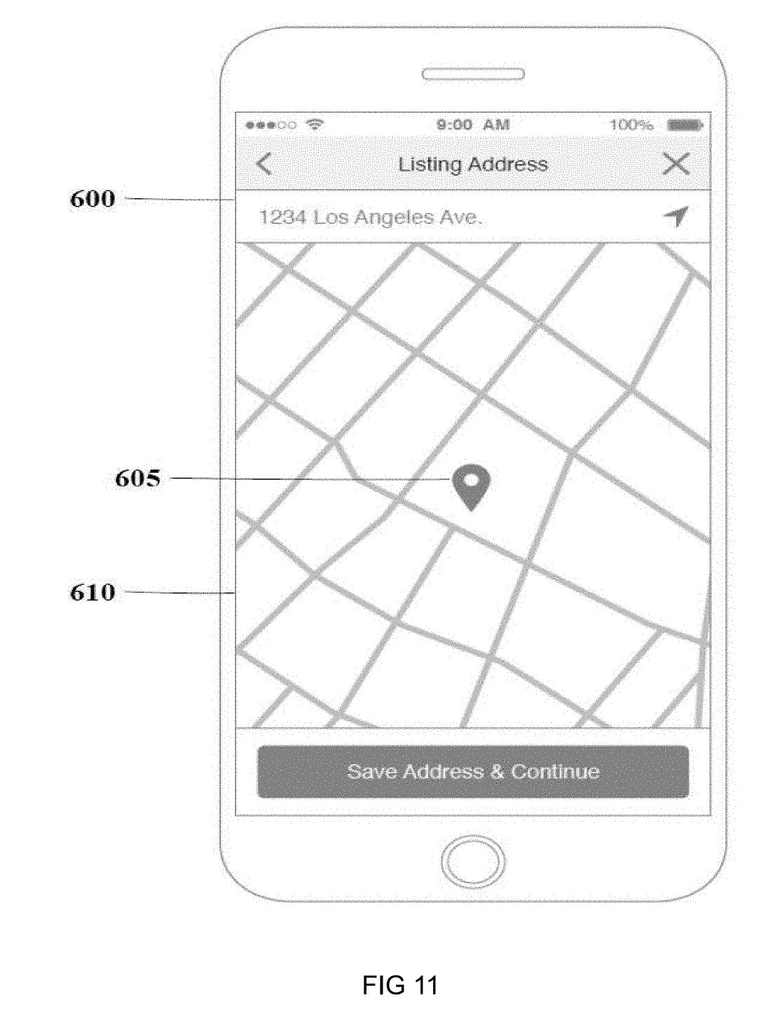

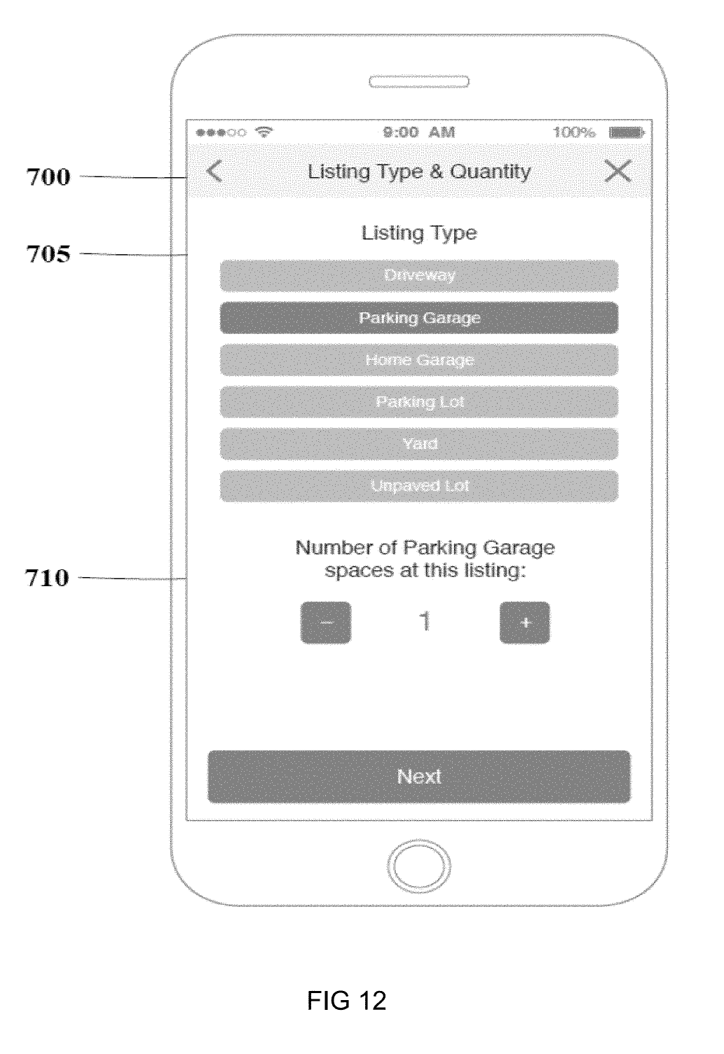

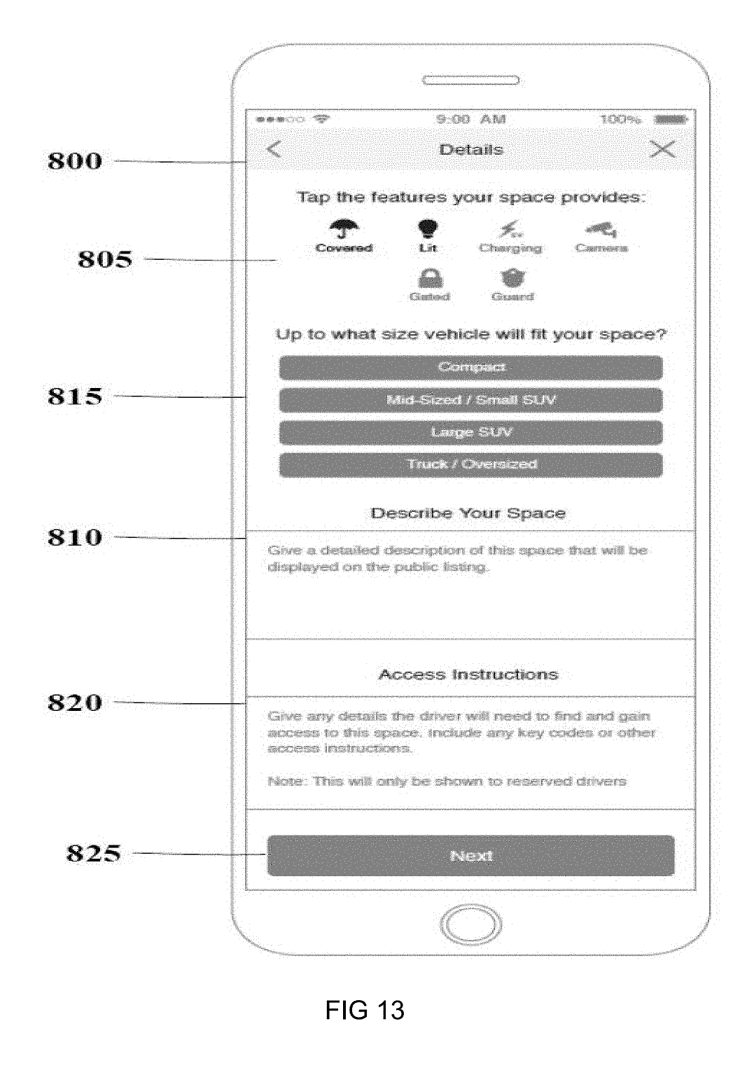

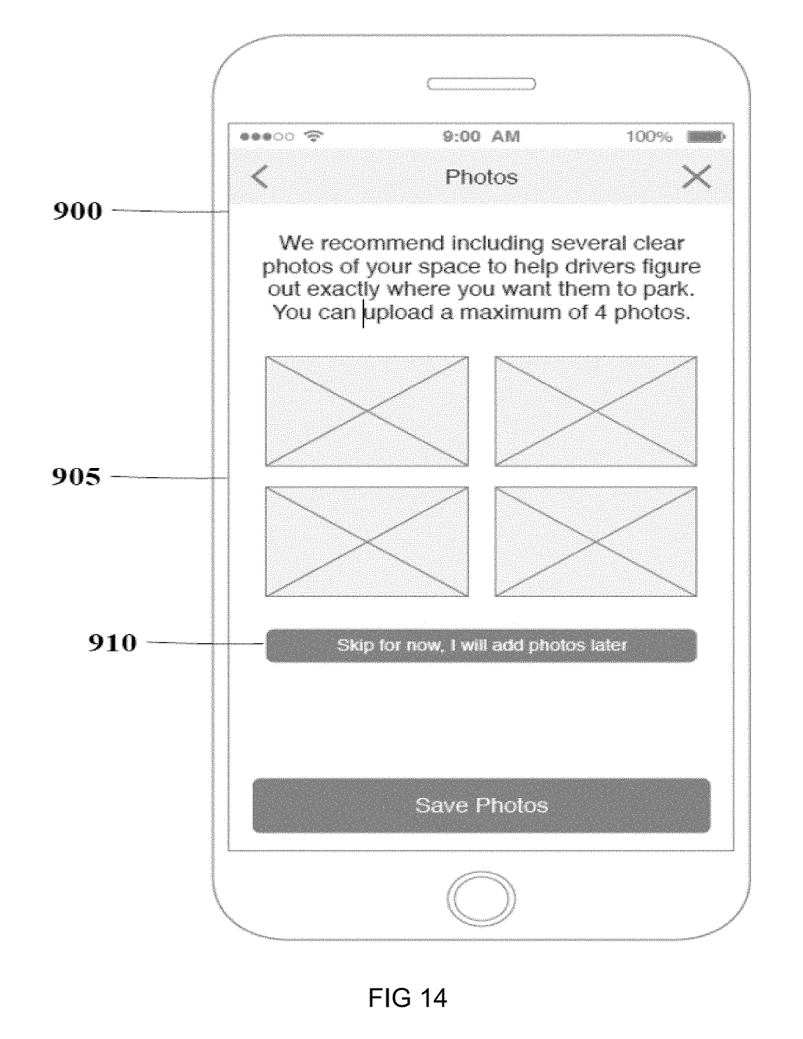

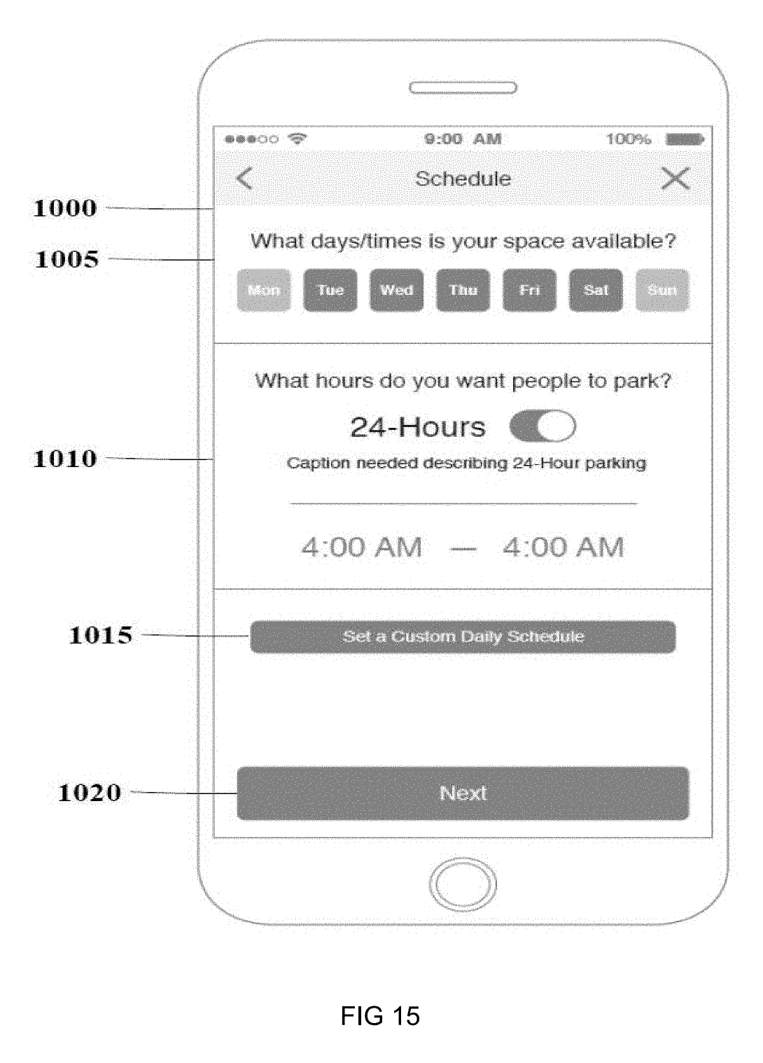

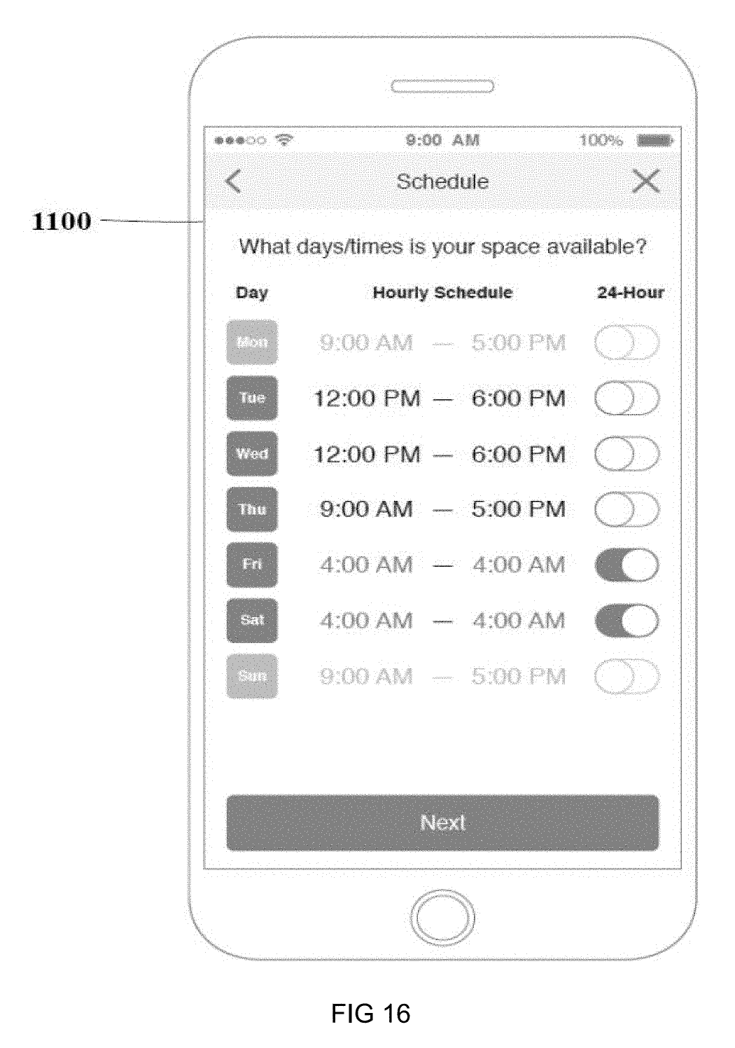

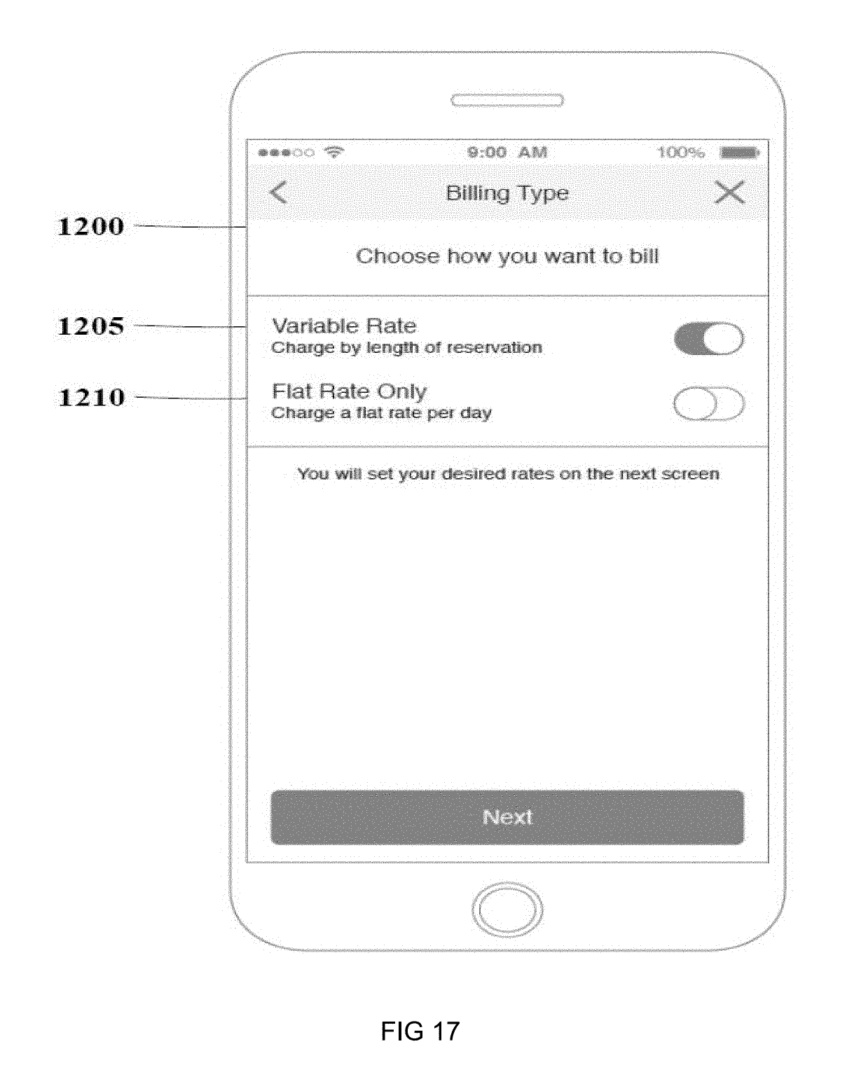

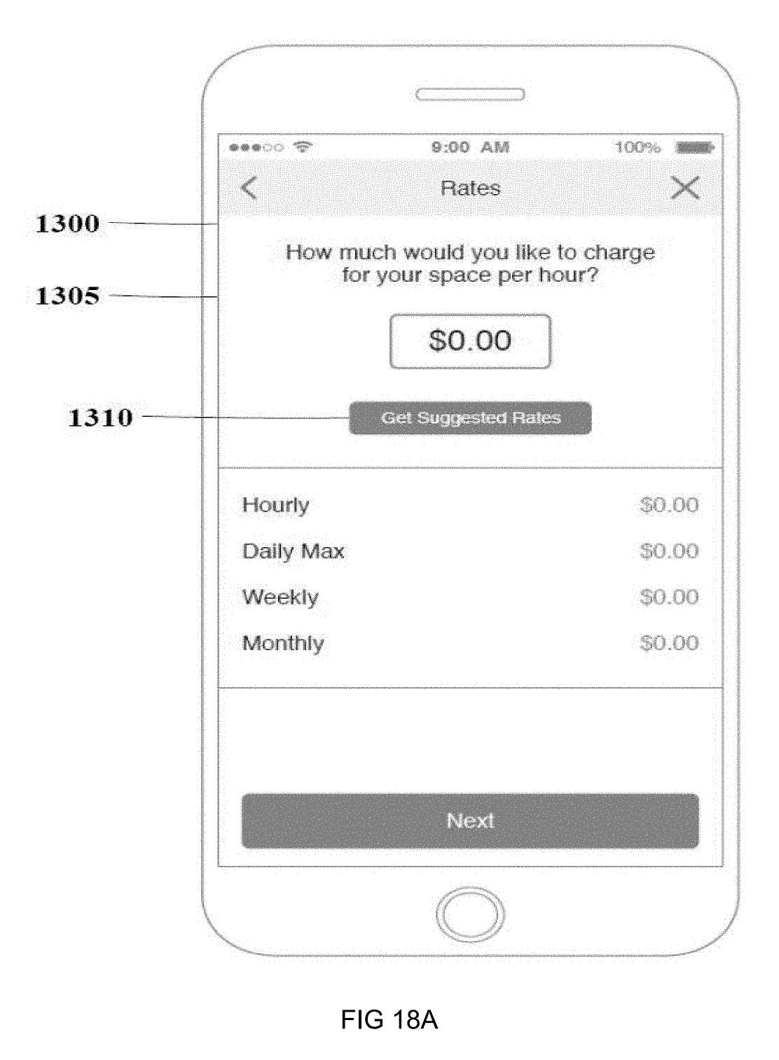

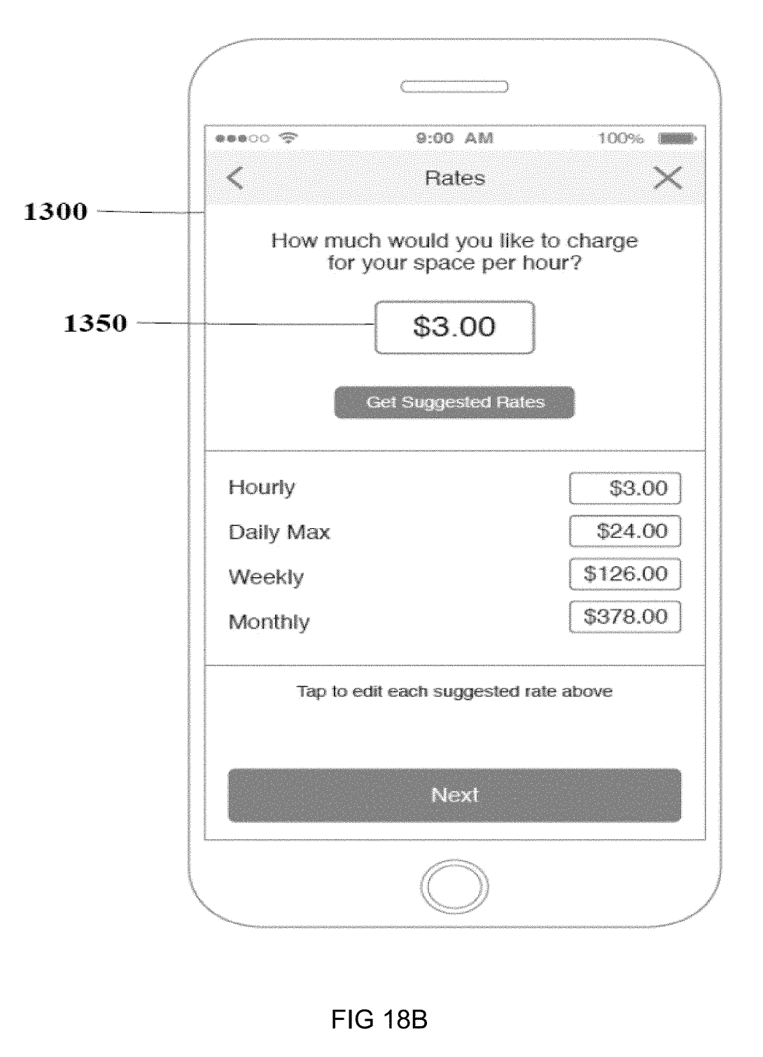

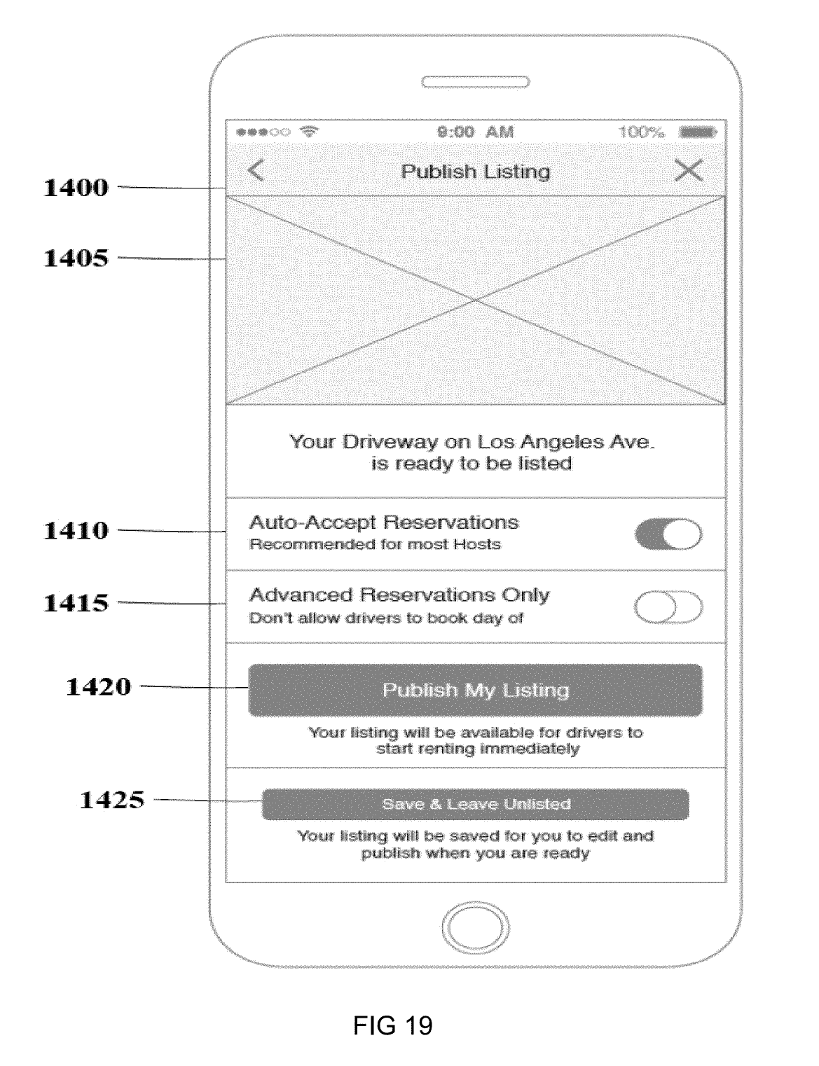

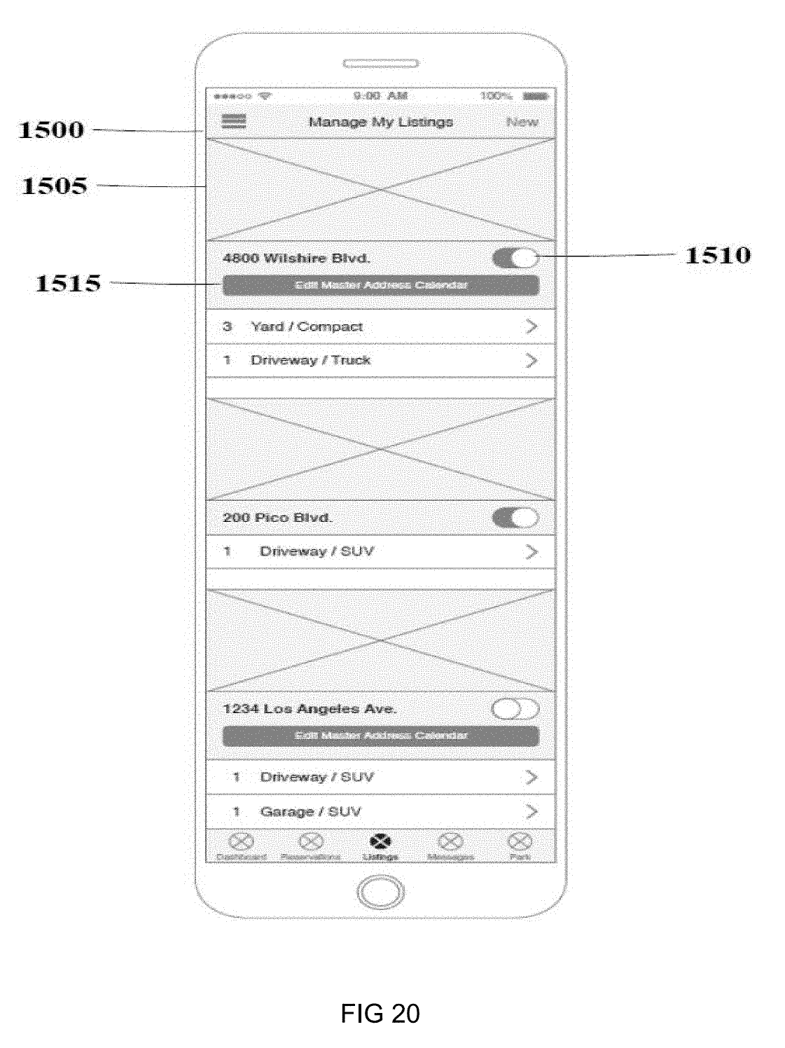

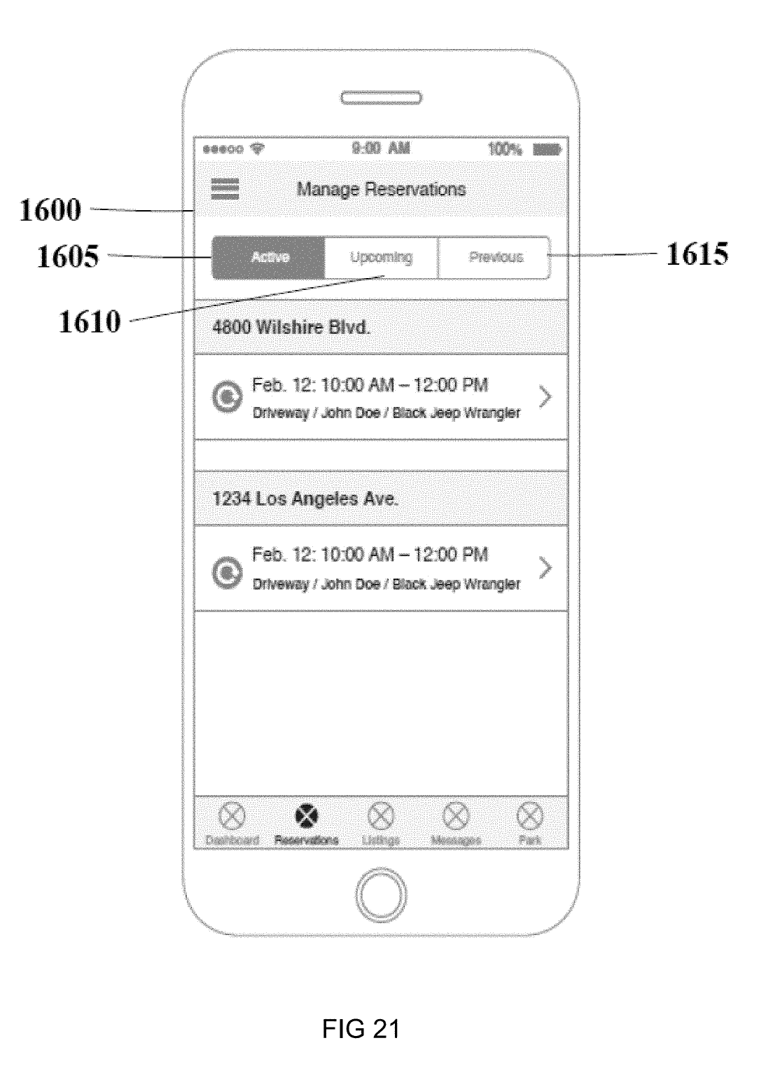

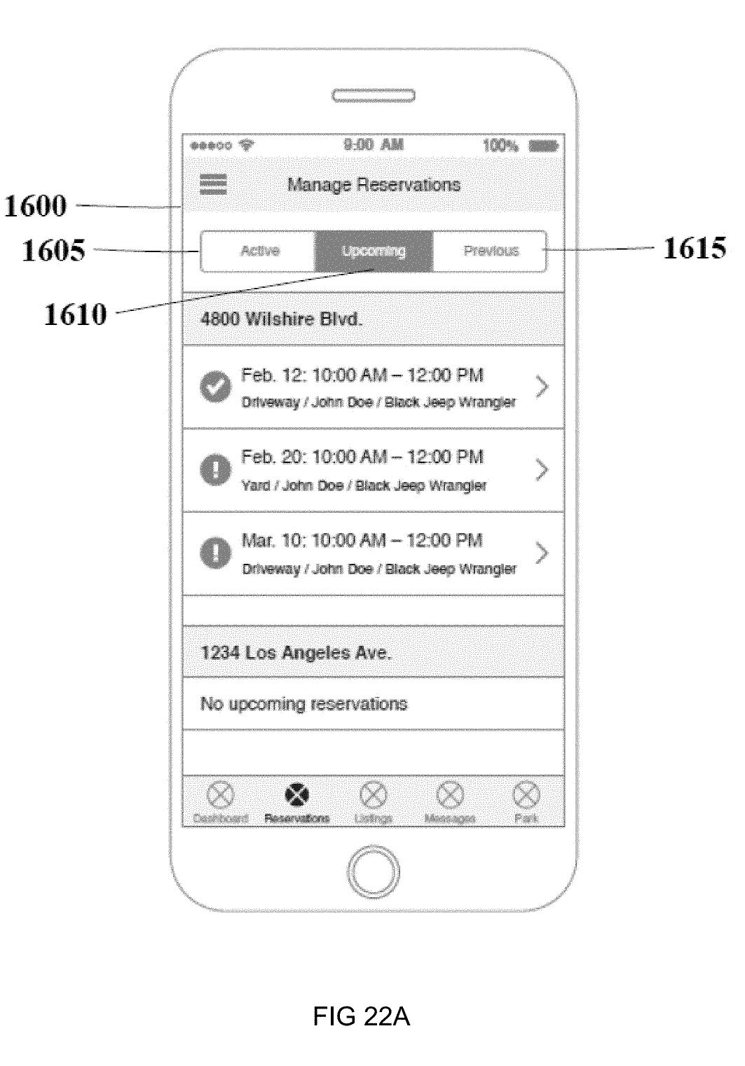

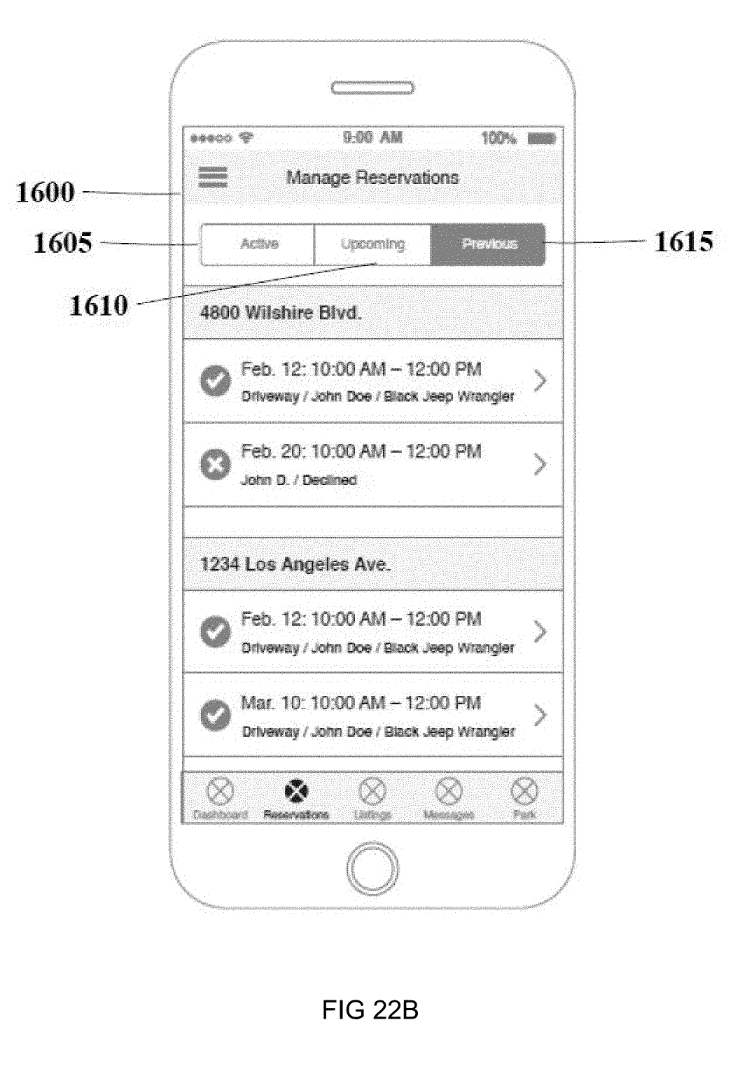

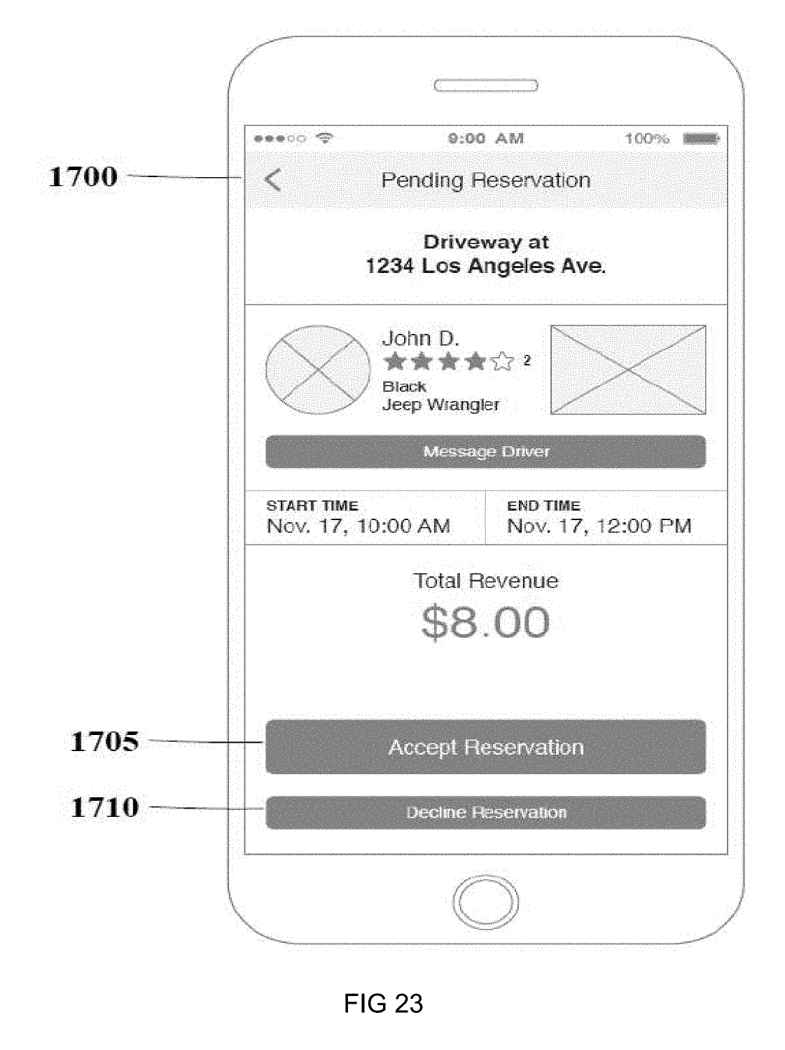

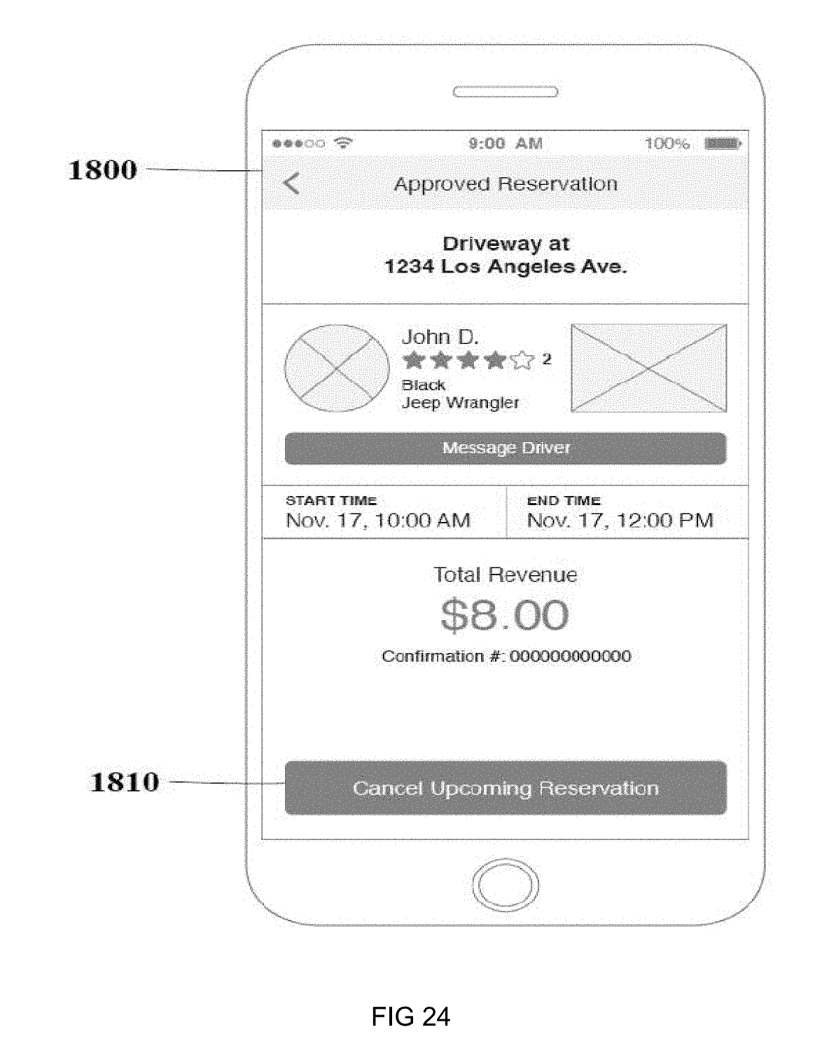

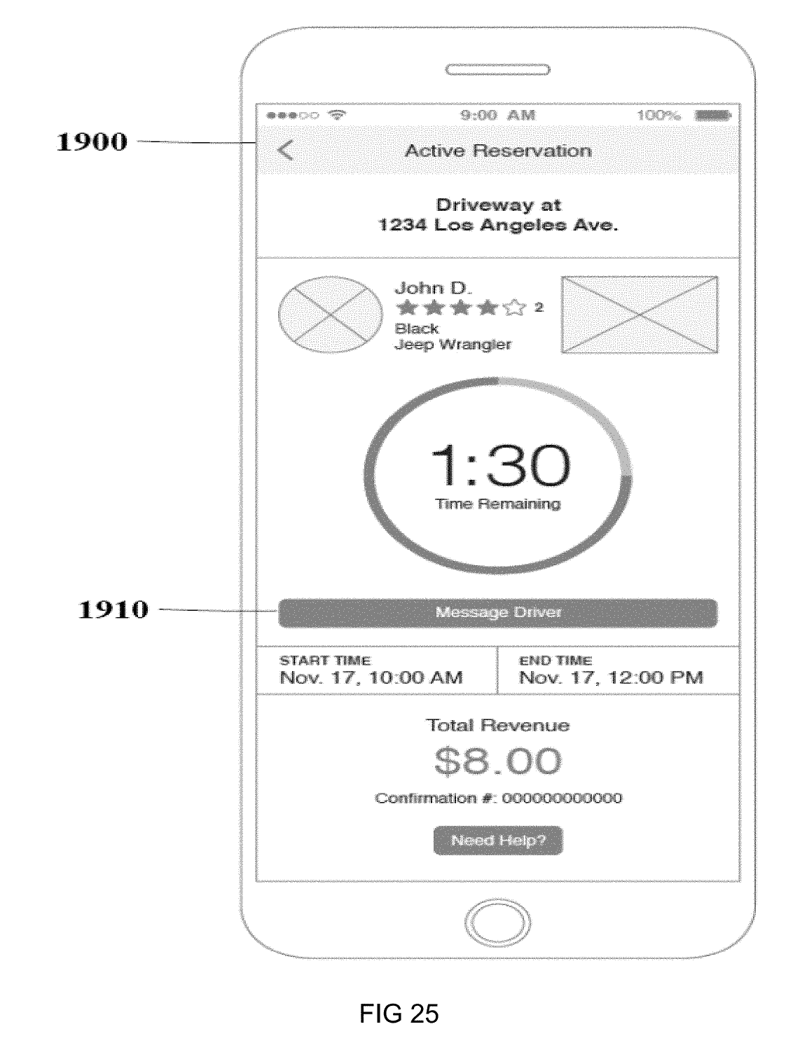

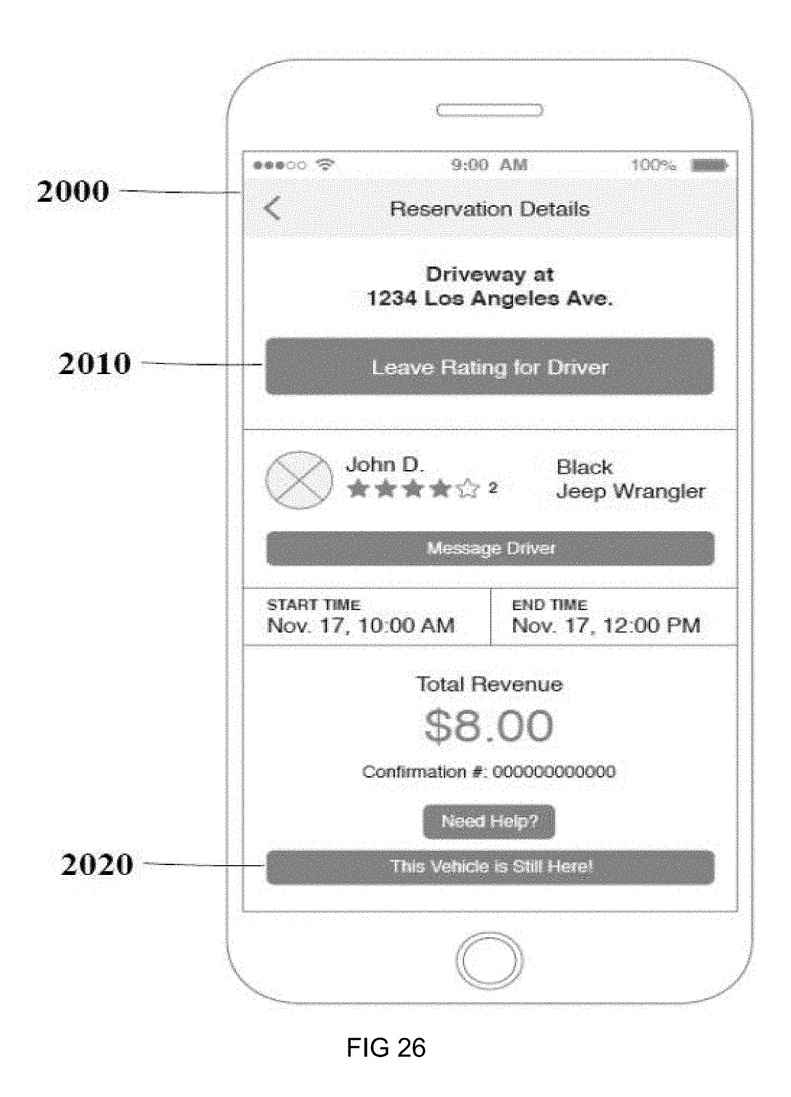

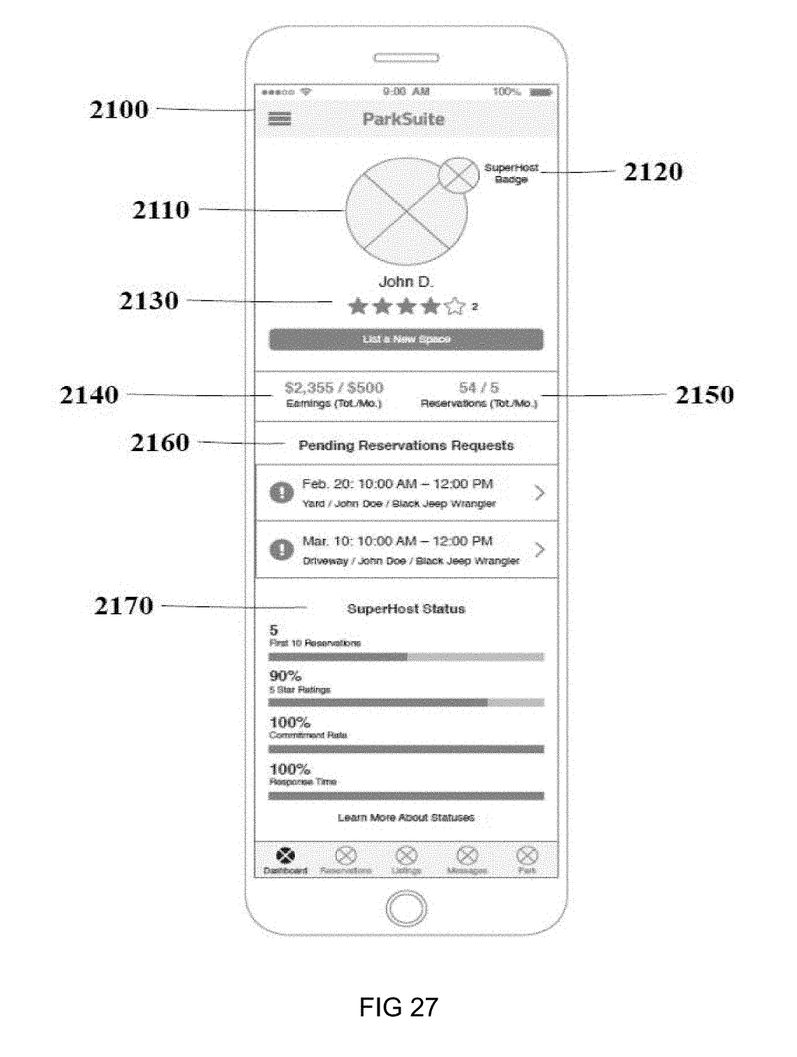

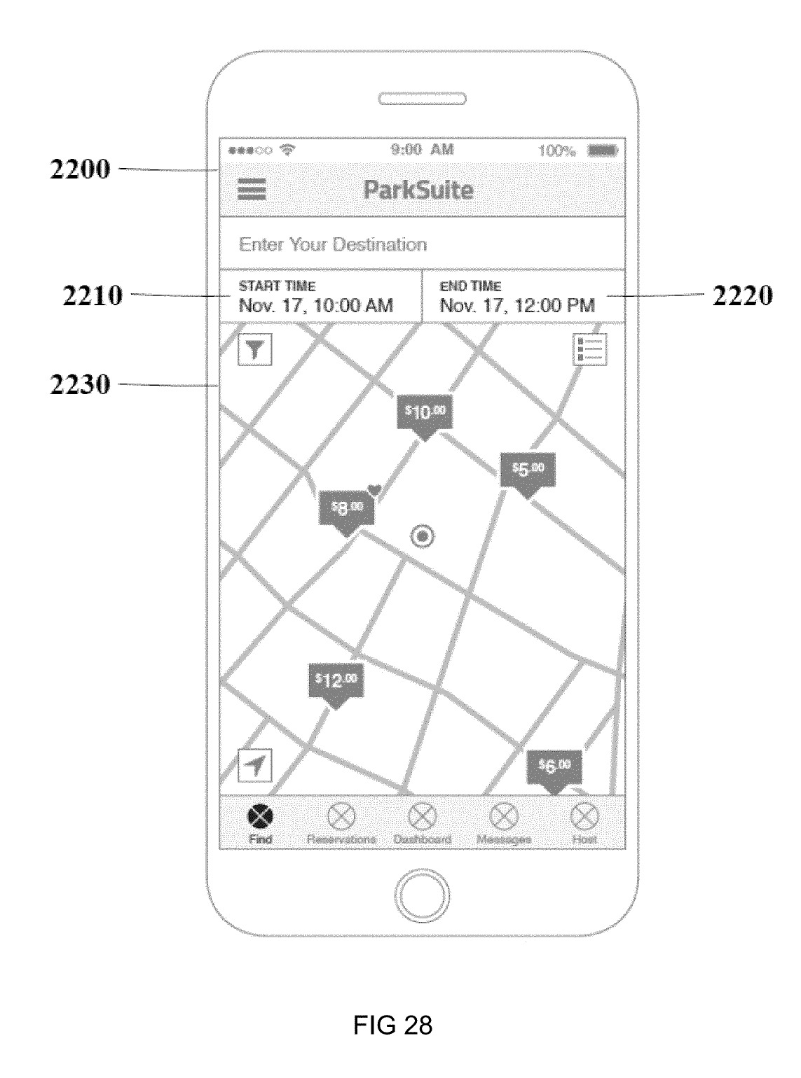

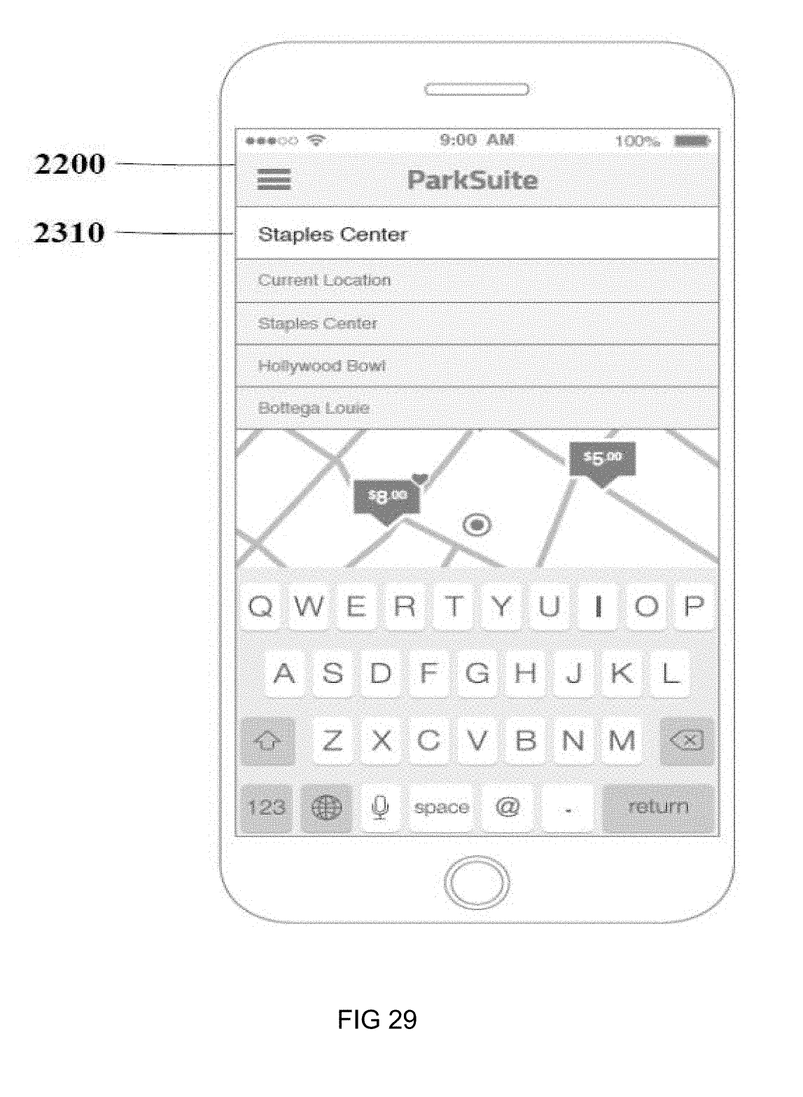

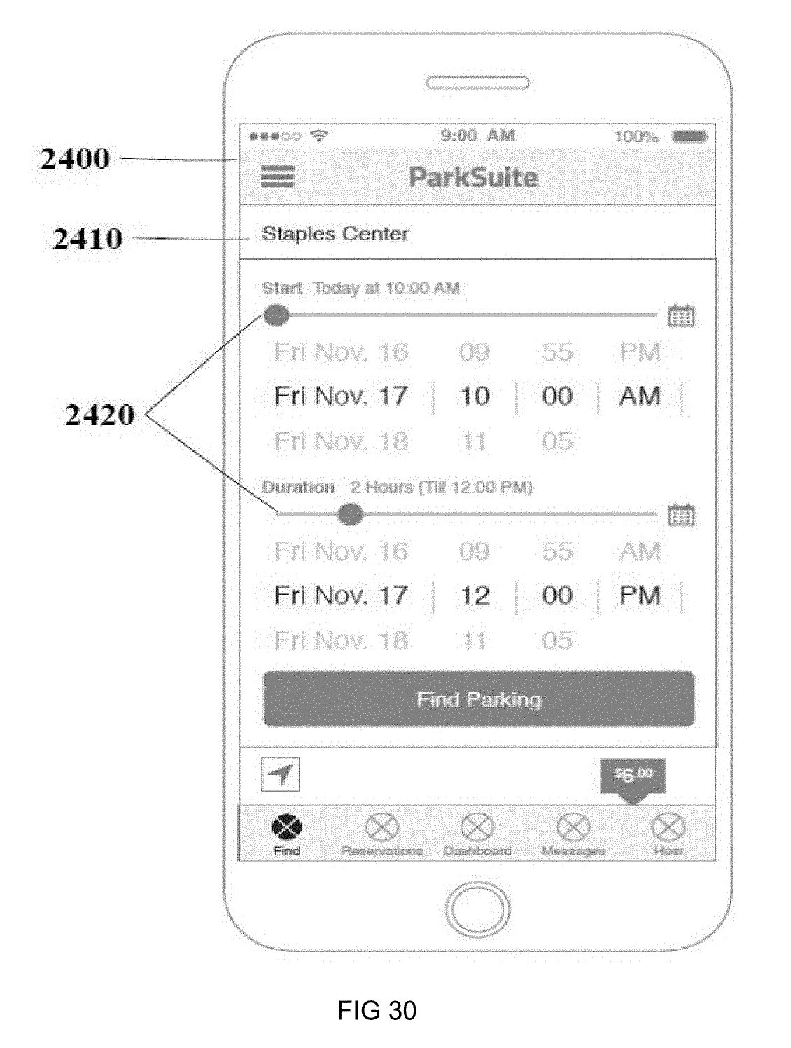

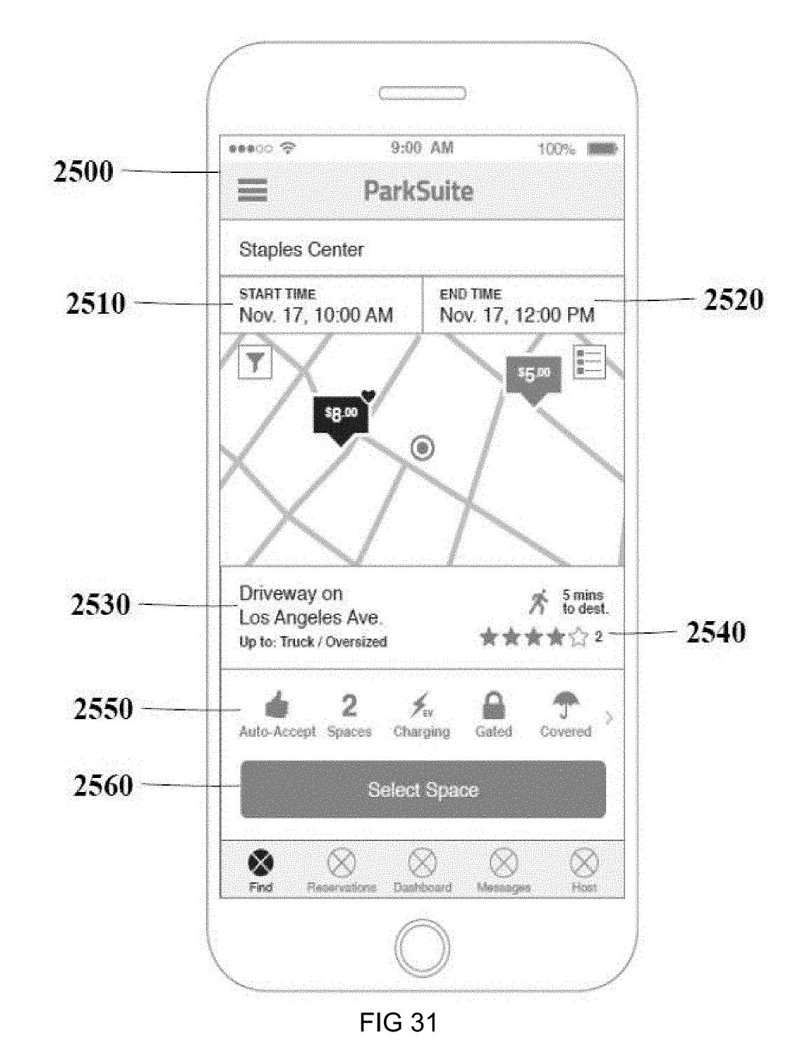

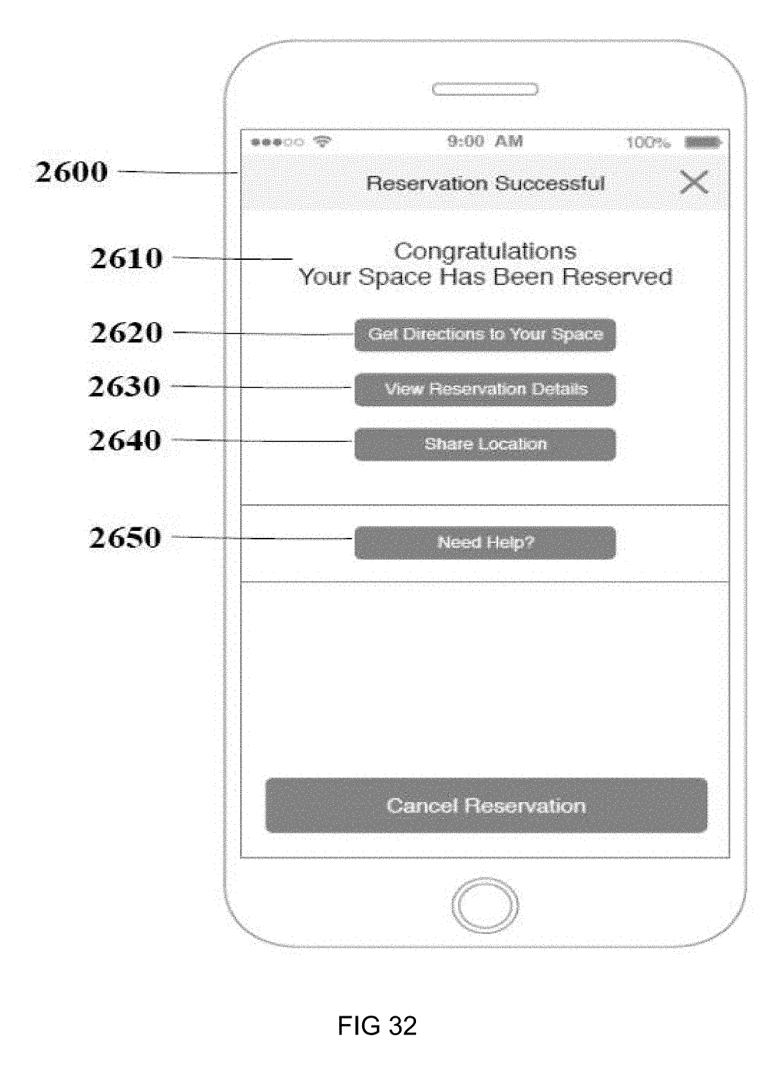

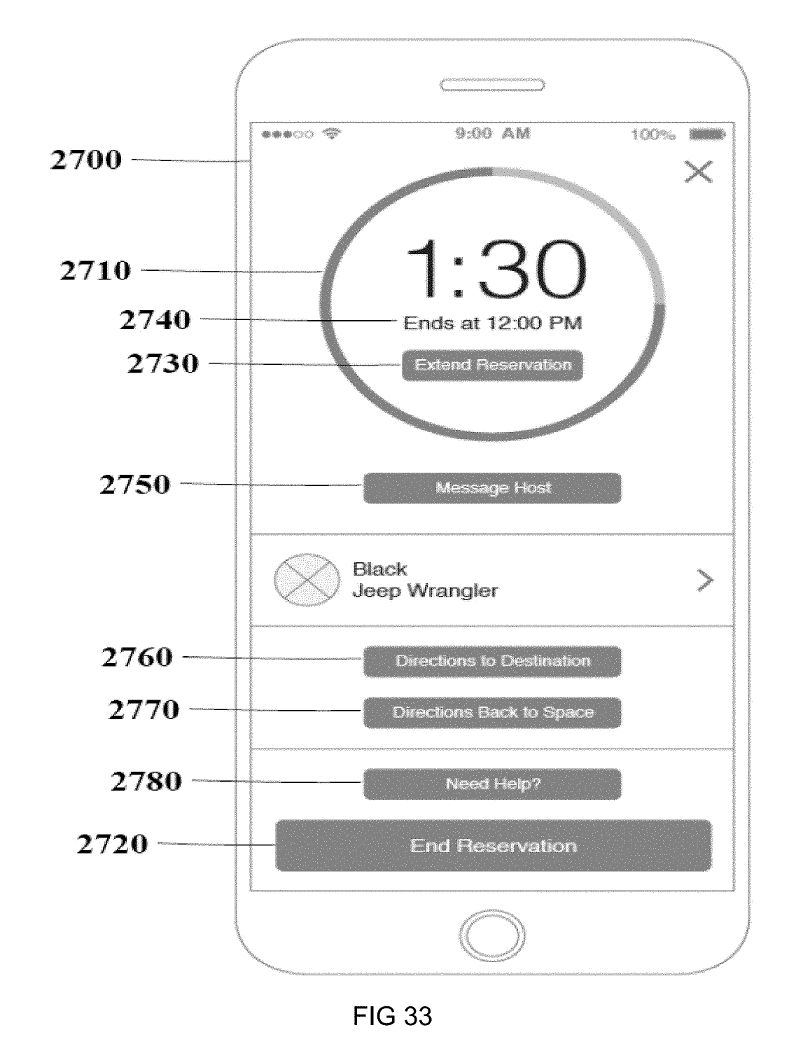

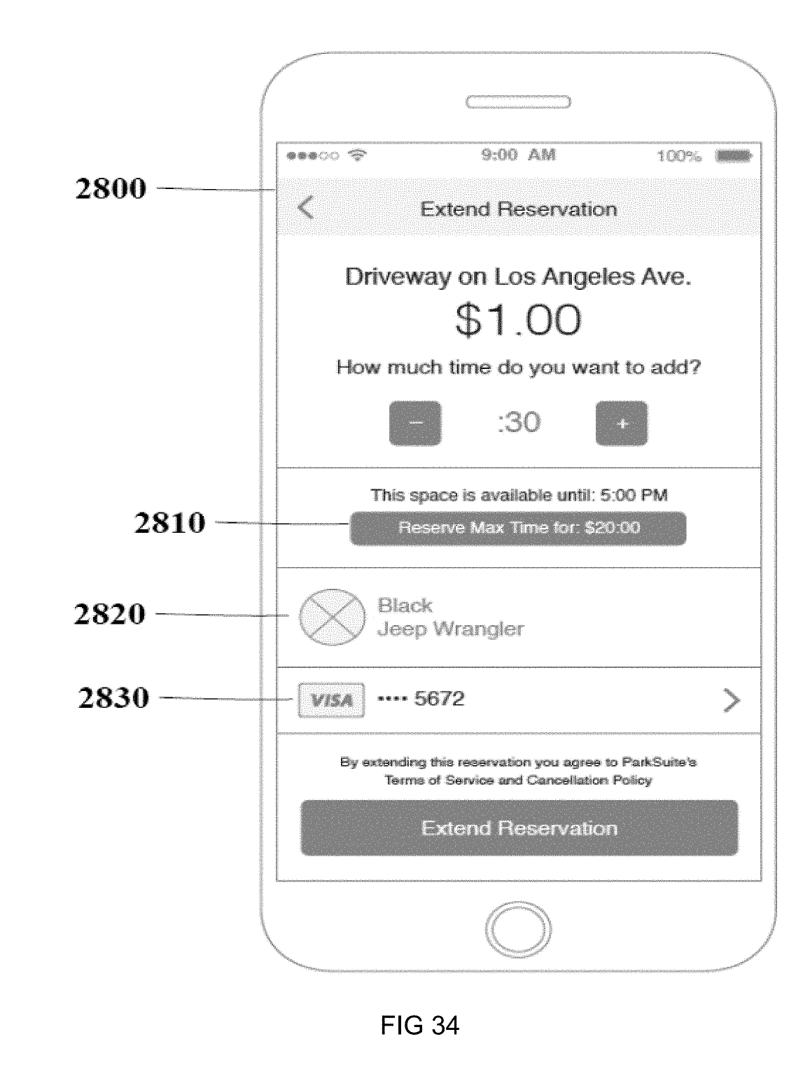

FIGS. 7-34 illustrate exemplary screen shots of prompts and information in aspects of an apparatus, article, system and method for automated, electronic management of parking space rental transactions in a marketplace for parking space rentals over a communications network, according to embodiments.

What is claimed is:

1. A system for automated electronic management of parking space rental transactions in a marketplace for parking space rentals over a distributed communications network, the system comprising:
a server comprising a processor operably coupled to memory;
a network adapter operably coupled to the processor, the network adapter enabling communication over the distributed communications network;
a user onboarding module providing a user profile, the user profile including at least one of the following:
driver profile information including a driver identifier, host profile information including a host identifier;
a host dashboard module providing a host management input prompt, the host dashboard module receiving host management input in relation to the host management input prompt, the host dashboard module providing host management information in relation to the host identifier, the host dashboard module processing host management input to provide host management actions;
a listings management module providing a listing management input prompt, the listings management module receiving listing management input in relation to the listing management input prompt, the listings management module providing a listing creation input prompt, the listings management module receiving listing creation input in relation to the listing creation prompt, the listings management module processing the listing creation input to provide listing creation information in relation to a host identifier, the listings management module processing the listing management input to provide listing management information in relation to a host identifier, the listing management information having a listing management information hierarchy as follows:
a listing group identifier in relation to a common listing address, a listing group type identifier in relation to a common listing group identifier, a listing space identifier defined in relation to a common listing group type identifier;
a parking space database storing parking space information including at least the following:
listing space identifier, listing group type identifier, listing group identifier, listing address, listing size identifier, and listing status information;
a space finding module providing a space finding prompt, the space finding module receiving space finding input responsive to the spaced finding prompt, the space finding module processing the space finding input to provide space availability information in relation to driver destination information and driver destination time window information;
a driver reservation request module providing a reservation request input prompt, the driver reservation request module receiving reservation request input responsive to the reservation request input prompt, the driver reservation request module processing reservation request input in relation to listing management information to provide driver reservation request information;
a host reservation management module providing a reservation management input prompt, the host reservation management module receiving reservation management input responsive to the reservation management input prompt, the host reservation management module processing the reservation management input to provide reservation management information in relation to driver reservation request information;
a space blocking module providing a blocking input prompt, the space blocking module receiving blocking input responsive to the blocking input prompt, the space blocking module processing the blocking input to provide space blocking information in relation to reservation management information for a listing; and
a reservation extension module providing an extension input prompt, the reservation extension module receiving extension input responsive to the extension input prompt, the reservation extension module processing the extension input to provide reservation extension information in relation to reservation management information for a listing.

2. A system according to claim 1 and further comprising:
an advance reservation search module providing an advance reservation search input prompt, the advance reservation search module receiving advance reservation search input responsive to the advance reservation search input prompt, the advance reservation search module processing the advance reservation search input to provide advance reservation information in relation to a future destination and a future time window.

3. Apparatus providing automated electronic management of parking space rental transactions in a marketplace for parking space rentals over a distributed communications network, the apparatus comprising:
a server comprising a processor operably coupled to memory;
a network adapter operably coupled to the processor, the network adapter enabling communication over the distributed communications network;
a computer readable medium having computer implementable instructions stored in memory, that, when executed by a processor, cause the processor to provide:
a user onboarding module providing a user profile, the user profile including at least one of the following:
driver profile information including a driver identifier, host profile information including a host identifier;
a host dashboard module providing a host management input prompt, the host dashboard module receiving host management input in relation to the host management input prompt, the host dashboard module providing host management information in relation to the host identifier, the host dashboard module processing host management input to provide host management actions;
a listings management module providing a listing management input prompt, the listings management module receiving listing management input in relation to the listing management input prompt, the listings management module providing a listing creation input prompt, the listings management module receiving listing creation input in relation to the listing creation prompt, the listings management module processing the listing creation input to provide listing creation information in relation to a host identifier, the listings management module processing the listing management input to provide listing management information in relation to a host identifier, the listing management information having a listing management information hierarchy as follows:
a listing group identifier in relation to a common listing address, a listing group type identifier in relation to a common listing group identifier, a listing space identifier defined in relation to a common listing group type identifier;
a parking space database storing parking space information including at least the following:
listing space identifier, listing group type identifier, listing group identifier, listing address, listing size identifier, and listing status information;
a space finding module providing a space finding prompt, the space finding module receiving space finding input responsive to the spaced finding prompt, the space finding module processing the space finding input to provide space availability information in relation to driver destination information and driver destination time window information;
a driver reservation request module providing a reservation request input prompt, the driver reservation request module receiving reservation request input responsive to the reservation request input prompt, the driver reservation request module processing reservation request input in relation to listing management information to provide driver reservation request information;
a host reservation management module providing a reservation management input prompt, the host reservation management module receiving reservation management input responsive to the reservation management input prompt, the host reservation management module processing the reservation management input to provide reservation management information in relation to driver reservation request information;
a space blocking module providing a blocking input prompt, the space blocking module receiving blocking input responsive to the blocking input prompt, the space blocking module processing the blocking input to provide space blocking information in relation to reservation management information for a listing; and
a reservation extension module providing an extension input prompt, the reservation extension module receiving extension input responsive to the extension input prompt, the reservation extension module processing the extension input to provide reservation extension information in relation to reservation management information for a listing.

4. Apparatus according to claim 3 and further comprising:
an advance reservation search module providing an advance reservation search input prompt, the advance reservation search module receiving advance reservation search input responsive to the advance reservation search input prompt, the advance reservation search module processing the advance reservation search input to provide advance reservation information in relation to a future destination and a future time window.

5. A method for automated electronic management of parking space rental transactions in a marketplace for parking space rentals by a server over a distributed communications network, the method comprising:
providing a user onboarding module producing a user profile, the user profile including at least one of the following:
driver profile information including a driver identifier, host profile information including a host identifier;
providing a host dashboard module producing a host management input prompt, the host dashboard module receiving host management input in relation to the host management input prompt, the host dashboard module providing host management information in relation to the host identifier, the host dashboard module processing host management input to provide host management actions;
providing a listings management module producing a listing management input prompt, the listings management module receiving listing management input in relation to the listing management input prompt, the listings management module providing a listing creation input prompt, the listings management module receiving listing creation input in relation to the listing creation prompt, the listings management module processing the listing creation input to provide listing creation information in relation to a host identifier, the listings management module processing the listing management input to provide listing management information in relation to a host identifier, the listing management information having a listing management information hierarchy as follows:
a listing group identifier in relation to a common listing address, a listing group type identifier in relation to a common listing group identifier, a listing space identifier defined in relation to a common listing group type identifier;
providing a parking space database, the parking space database storing parking space information including at least the following:
listing space identifier, listing group type identifier, listing group identifier, listing address, listing size identifier, and listing status information;
providing a space finding module producing a space finding prompt, the space finding module receiving space finding input responsive to the spaced finding prompt, the space finding module processing the space finding input to provide space availability information in relation to driver destination information and driver destination time window information;
providing a driver reservation request module producing a reservation request input prompt, the driver reservation request module receiving reservation request input responsive to the reservation request input prompt, the driver reservation request module processing reservation request input in relation to listing management information to provide driver reservation request information;
providing a host reservation management module producing a reservation management input prompt, the host reservation management module receiving reservation management input responsive to the reservation management input prompt, the host reservation management module processing the reservation management input to provide reservation management information in relation to driver reservation request information;
providing a space blocking module producing a blocking input prompt, the space blocking module receiving blocking input responsive to the blocking input prompt, the space blocking module processing the blocking input to provide space blocking information in relation to reservation management information for a listing; and
providing a reservation extension module producing an extension input prompt, the reservation extension module receiving extension input responsive to the extension input prompt, the reservation extension module processing the extension input to provide reservation extension information in relation to reservation management information for a listing.

6. A method according to claim 5 and further comprising:
providing an advance reservation search module,
providing an advance reservation search input prompt, by the advance reservation search module;
receiving advance reservation search input responsive to the advance reservation search input prompt, by the advance reservation search module;
processing the advance reservation search input by the advance reservation search module to provide advance reservation information in relation to a future destination and a future time window.

7. An article providing automated electronic management of parking space rental transactions in a marketplace for parking space rentals by a server over a distributed communications network, the article comprising:
a computer readable medium having computer implementable instructions stored in memory, that, when executed by a processor, causes the processor to provide:
a user onboarding module providing a user profile, the user profile including at least one of the following:
driver profile information including a driver identifier, host profile information including a host identifier;
a host dashboard module providing a host management input prompt, the host dashboard module receiving host management input in relation to the host management input prompt, the host dashboard module providing host management information in relation to the host identifier, the host dashboard module processing host management input to provide host management actions;
a listings management module providing a listing management input prompt, the listings management module receiving listing management input in relation to the listing management input prompt, the listings management module providing a listing creation input prompt, the listings management module receiving listing creation input in relation to the listing creation prompt, the listings management module processing the listing creation input to provide listing creation information in relation to a host identifier, the listings management module processing the listing management input to provide listing management information in relation to a host identifier, the listing management information having a listing management information hierarchy as follows:
a listing group identifier in relation to a common listing address, a listing group type identifier in relation to a common listing group identifier, a listing space identifier defined in relation to a common listing group type identifier;
a parking space database storing parking space information including at least the following:
listing space identifier, listing group type identifier, listing group identifier, listing address, listing size identifier, and listing status information;
a space finding module providing a space finding prompt, the space finding module receiving space finding input responsive to the spaced finding prompt, the space finding module processing the space finding input to provide space availability information in relation to driver destination information and driver destination time window information;
a driver reservation request module providing a reservation request input prompt, the driver reservation request module receiving reservation request input responsive to the reservation request input prompt, the driver reservation request module processing reservation request input in relation to listing management information to provide driver reservation request information;
a host reservation management module providing a reservation management input prompt, the host reservation management module receiving reservation management input responsive to the reservation management input prompt, the host reservation management module processing the reservation management input to provide reservation management information in relation to driver reservation request information;
a space blocking module providing a blocking input prompt, the space blocking module receiving blocking input responsive to the blocking input prompt, the space blocking module processing the blocking input to provide space blocking information in relation to reservation management information for a listing; and
a reservation extension module providing an extension input prompt, the reservation extension module receiving extension input responsive to the extension input prompt, the reservation extension module processing the extension input to provide reservation extension information in relation to reservation management information for a listing.
8. An article according to claim 7 and further comprising:
an advance reservation search module providing an advance reservation search input prompt, the advance reservation search module receiving advance reservation search input responsive to the advance reservation search input prompt, the advance reservation search module processing the advance reservation search input to provide advance reservation information in relation to a future destination and a future time window.
